(19) United States
(12) Patent Application Publication
(10) Pub. No.: US 2024/0110000 A1
(43) Pub. Date: Apr. 4, 2024

(54) CAST POLYURETHANE COMPOSITIONS AND USES THEREOF

(71) Applicant: Checkerspot, Inc., Alameda, CA (US)

(72) Inventors: Charles RAND, Holladay, UT (US); Garrett WITMER, Salt Lake City, UT (US); Daniel MALMROSE, Salt Lake City, UT (US); Scott FRANKLIN, Woodside, CA (US)

(21) Appl. No.: 18/486,450

(22) Filed: Oct. 13, 2023

Related U.S. Application Data
(63) Continuation of application No. PCT/US2022/024606, filed on Apr. 13, 2022.
(60) Provisional application No. 63/281,139, filed on Nov. 19, 2021.
(60) Provisional application No. 63/175,377, filed on Apr. 15, 2021.

(51) Int. Cl. C08G 18/42; C08G 18/12; C08G 18/20; C08G 18/24; C08G 18/48; C08G 18/69; C08K 3/34; C08L 91/00

(52) U.S. Cl. CPC C08G 18/4236; C08G 18/12; C08G 18/2063; C08G 18/246; C08G 18/4854; C08G 18/69; C08K 3/34; C08L 91/00

(57) ABSTRACT

Provided herein are cast polyurethane compositions and applications thereof in sporting goods equipment, including, for example, alpine skis, touring skis, cross country skis, approach skis, split boards, snowboards, surfboards, paddleboards, and water skis. Further provided herein are methods of preparing said cast polyurethane compositions.

### CROSS-REFERENCE

This application is a continuation of International Application No. PCT/US22/24606 filed Apr. 13, 2022, which claims the benefit of U.S. Provisional Application No. 63/175,377, filed Apr. 15, 2021, and U.S. Provisional Application No. 63/281,139, filed Nov. 19, 2021, each of which is incorporated herein by reference in its entirety.

### BACKGROUND

Polyurethanes can be produced via the condensation of a hydroxyl functionality, such as a polyol, with an isocyanate moiety. As a polymer class, polyurethanes are quite diverse and unique among plastics as the chemical structure of polyurethanes is not a highly repetitive unit. As a consequence, polyurethanes having the same general physical properties can have dramatically different chemical compositions. Because of their diverse structural makeup, polyurethanes come in myriad forms and can be used for the production of thermoset materials, resins, films, coatings, foams, sealants, adhesives, and elastomers. Polyols are typically derived from petroleum feedstocks. Biobased polyols can serve as a sustainable, renewable alternative to petrochemical-based polyols. while providing polyurethanes materials with novel functionalities.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In some aspects, the present disclosure provides a reaction mixture comprising: a) a biobased polyol at an amount of about 30% to about 70% on a weight-by-weight basis of the reaction mixture; b) an isocyanate at an amount of about 15% to about 60% on a weight-by-weight basis of the reaction mixture; c) a catalyst at an amount of about 0.1% to about 2% on a weight-by-weight basis of the reaction mixture; d) a zeolite at an amount of about 0.1% to about 5% on a weight-by-weight basis of the reaction mixture; and e) one or more macrodiols at an amount of about 1% to about 15% on a weight-by-weight basis of the reaction mixture.

In some aspects, the present disclosure provides a method for producing an impact resistant, biobased cast polyurethane resin, the method comprising preparing the reaction mixture comprising: a) a biobased polyol at an amount of about 30% to about 70% on a weight-by-weight basis of the reaction mixture; b) an isocyanate at an amount of about 15% to about 60% on a weight-by-weight basis of the reaction mixture; c) a catalyst at an amount of about 0.1% to about 2% on a weight-by-weight basis of the reaction mixture; d) a zeolite at an amount of about 0.1% to about 5% on a weight-by-weight basis of the reaction mixture; and e) one or more macrodiols at an amount of about 1% to about 15% on a weight-by-weight basis of the reaction mixture, thereby producing the impact resistant, biobased cast polyurethane resin, wherein the impact resistant, biobased cast polyurethane resin has an impact resistance of greater than 20 kJ/m² as assessed by Charpy testing at −20° C.

In some aspects, the present disclosure provides a method for preparing an impact resistant, biobased cast polyurethane resin, the method comprising reacting: a polyol at an amount of about 30% to about 70% on a weight-by-weight basis of the cast polyurethane resin; one or more macrodiols at an amount of about 1% to about 15% on a weight-by-weight basis of the cast polyurethane resin; and a zeolite at an amount of about 0.1% to about 5% on a weight-by-weight basis of the cast polyurethane resin with an isocyanate at an amount of about 15% to about 60% on a weight-by-weight basis of the cast polyurethane resin in the presence of a catalyst at an amount of about 0.1% to about 2% on a weight-by-weight basis of the cast polyurethane resin, thereby preparing the impact resistant, biobased cast polyurethane resin, wherein the impact resistant, biobased cast polyurethane resin has an impact resistance of greater than 20 kJ/m² as assessed by Charpy testing at −20° C.

In some aspects, the present disclosure provides an impact resistant, biobased cast polyurethane resin produced by the reaction mixture comprising: a) a biobased polyol at an amount of about 30% to about 70% on a weight-by-weight basis of the reaction mixture; b) an isocyanate at an amount of about 15% to about 60% on a weight-by-weight basis of the reaction mixture; c) a catalyst at an amount of about 0.1% to about 2% on a weight-by-weight basis of the reaction mixture; d) a zeolite at an amount of about 0.1% to about 5% on a weight-by-weight basis of the reaction mixture; and e) one or more macrodiols at an amount of about 1% to about 15% on a weight-by-weight basis of the reaction mixture.

In some aspects, the present disclosure provides an impact resistant, biobased cast polyurethane resin produced by a method comprising reacting: a polyol at an amount of about 30% to about 70% on a weight-by-weight basis of the cast polyurethane resin; one or more macrodiols at an amount of about 1% to about 15% on a weight-by-weight basis of the cast polyurethane resin; and a zeolite at an amount of about 0.1% to about 5% on a weight-by-weight basis of the cast polyurethane resin with an isocyanate at an amount of about 15% to about 60% on a weight-by-weight basis of the cast polyurethane resin in the presence of a catalyst at an amount of about 0.1% to about 2% on a weight-by-weight basis of the cast polyurethane resin, thereby preparing the impact resistant, biobased cast polyurethane resin, wherein the impact resistant, biobased cast polyurethane resin has an impact resistance of greater than 20 kJ/m² as assessed by Charpy testing at −20° C.

In some aspects, the present disclosure provides an impact resistant, biobased cast polyurethane resin comprising: a) a biobased polyol at an amount of about 30% to about 70% on a weight-by-weight basis of the resin; b) an isocyanate at an amount of about 15% to about 60% on a weight-by-weight basis of the resin; c) a catalyst at an amount of about 0.1% to about 2% on a weight-by-weight basis of the resin; d) a zeolite at an amount of about 0.1% to about 5% on a weight-by-weight basis of the resin; and e) one or more macrodiols at an amount of about 1% to about 15% on a weight-by-weight basis of the resin.

In some aspects, the present disclosure provides a kit comprising:
a) an isocyanate component, wherein the isocyanate component comprises:
   i) 95% to 99% of an isocyanate on a weight-by-weight basis; and
   ii) 1% to 5% of an algal oil polyol on a weight-by-weight basis; and
b) a polyol component, wherein the polyol component comprises:
   i) 80% to 85% of the algal oil polyol on a weight-by-weight basis;
   ii) 1% to 10% of 1,4-butanediol on a weight-by-weight basis;
   iii) 1% to 5% of a zeolite on a weight-by-weight basis;
   iv) 1% to 5% of one or more pigments on a weight-by-weight basis; and
   v) 0.001% to 1% of a catalyst on a weight-by-weight basis.

In some aspects, the present disclosure provides a kit comprising:
a) an isocyanate component, wherein the isocyanate component comprises:
   i) 85% to 90% of an isocyanate on a weight-by-weight basis; and
   ii) 10% to 15% of an algal oil polyol on a weight-by-weight basis; and
b) a polyol component, wherein the polyol component comprises:
   i) 80% to 85% of the algal oil polyol on a weight-by-weight basis;
   ii) 1% to 10% of a polybutadiene diol on a weight-by-weight basis;
   iii) 1% to 5% of a zeolite on a weight-by-weight basis;
   iv) 1% to 5% of one or more pigments on a weight-by-weight basis; and
   v) 0.01% to 1% of a catalyst on a weight-by-weight basis.

In some aspects, the present disclosure provides a kit comprising:
a) an isocyanate component, wherein the isocyanate component comprises:
b) a polyol component, wherein the polyol component comprises:
   i) 80% to 85% of the algal oil polyol on a weight-by-weight basis;
   ii) 5% to 10% of a refined, bleached, and deodorized algal oil;
   iii) 1% to 5% of 1,4-butanediol on a weight-by-weight basis;
   iv) 1% to 5% of a polybutadiene diol on a weight-by-weight basis;
   v) 1% to 5% of a zeolite on a weight-by-weight basis;
   vi) 1% to 5% of one or more pigments on a weight-by-weight basis; and
   vii) 0.1% to 1% of a catalyst on a weight-by-weight basis.

In some aspects, the present disclosure provides a kit comprising:
a) an isocyanate component, wherein the isocyanate component comprises:
   i) 70% to 80% of an isocyanate on a weight-by-weight basis;
   ii) 10% to 15% of an algal oil polyol on a weight-by-weight basis; and
   iii) 10% to 15% of a refined, bleached, and deodorized algal oil; and
b) a polyol component, wherein the polyol component comprises:
   i) 70% to 80% of the algal oil polyol on a weight-by-weight basis;
   ii) 10% to 15% of a refined, bleached, and deodorized algal oil;
   iii) 5% to 10% of a polybutadiene diol on a weight-by-weight basis;
   iv) 1% to 5% of a zeolite on a weight-by-weight basis;
   v) 1% to 5% of one or more pigments on a weight-by-weight basis; and
   vi) 0.1% to 1% of a catalyst on a weight-by-weight basis.

In some aspects, the present disclosure provides a kit comprising:
a) an isocyanate component, wherein the isocyanate component comprises:
   i) 70% to 80% of an isocyanate on a weight-by-weight basis;
   ii) 10% to 20% of an algal oil polyol on a weight-by-weight basis; and
   iii) 5% to 10% of a refined, bleached, and deodorized algal oil; and
b) a polyol component, wherein the polyol component comprises:
   i) 80% to 85% of the algal oil polyol on a weight-by-weight basis;
   ii) 1% to 5% of 1,4-butanediol on a weight-by-weight basis;
   iii) 5% to 10% of a polybutadiene diol on a weight-by-weight basis;
   iv) 1% to 5% of a zeolite on a weight-by-weight basis;
   v) 1% to 5% of one or more pigments on a weight-by-weight basis; and
   vi) 0.1% to 1% of a catalyst on a weight-by-weight basis.

In some aspects, the present disclosure provides an impact resistant, biobased cast polyurethane resin comprising 2% to 20% of a triglyceride oil on a weight-by-weight basis, wherein the impact resistant, biobased cast polyurethane resin has an impact resistance of greater than 130 kJ/m² as assessed by Charpy testing at −20° C. or lower, and wherein the impact resistant, biobased cast polyurethane resin has a Shore D hardness of greater than 50 as assessed by durometer testing at −20° C. or lower.

In some aspects, the present disclosure provides a cast urethane resin produced by any one of the methods described herein. In further aspects, the present disclosure provides a cast polyurethane resin produced from any one of the reaction mixtures described herein. In further aspects, the present disclosure provides a cast polyurethane resin produced by reacting components of any one of the reaction mixtures described herein in a vessel.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows the results of durometer testing of cast urethane coupons.

FIG. 2 shows the results of Charpy testing of cast urethane coupons.

### DETAILED DESCRIPTION

Provided herein are cast polyurethane formulations, methods of making thereof, and applications thereof. Further disclosed herein are biobased cast urethane formulations having improved impact resistance. These cast urethane resins can have a variety of material applications in consumer goods, including winter sporting goods, such as skis and snowboards.

As used herein, the term “triacylglycerol”, “triglyceride”, or “TAG” refers to esters between glycerol and three saturated and/or unsaturated fatty acids. Generally, fatty acids of TAGs have chain lengths of 8 carbon atoms or more.

As used herein, the term “biobased” generally refers to materials sourced from biological products or renewable agricultural material, including plant, animal, and marine materials, forestry materials, or an intermediate feedstock. In some embodiments, a biobased oil is an oil obtained from algae or microalgae, i.e., an algal oil. Biobased materials can serve as renewable alternatives to petrochemical materials in PU production. Biobased content of a formulation described herein can be measured on a weight-by-weight basis of the total formulation.

As used herein, the term “microbial oil” refers to an oil extracted from a microbe, e.g., an oleaginous, single-celled, eukaryotic or prokaryotic microorganism, including, but not limited to, yeast, microalgae, and bacteria.

As used herein, the term “polyol”, “biopolyol”, or “natural oil polyol” refers to triglycerols or fatty acid alcohols comprising hydroxyl functional groups. As used herein, the term “polyol derived from a TAG oil” generally refers to a polyol obtained from chemical conversion of a TAG oil, e.g., via epoxidation and ring opening, ozonolysis and reduction, or hydroformylation and reduction.

As used herein, the term “macrodiol” refers to a large, high molecular weight macromolecule containing two terminal hydroxyl groups. In some embodiments, a macrodiol is a diol having a molecular weight of greater than 500, greater than 1000, greater than 2000, or greater than 3000. In some embodiments, a macrodiol is a long chain monomeric diol.

As used herein, the term “molecular weight” or “MW” refers to molecular mass of a molecule. In some embodiments, molecular weight is in units of gram per mole (g/mol).

As used herein, the term “polyurethane”, “PU”, or “urethane” refers to a class of polymers comprised of carbamate (urethane) linkages formed between a polyol and an isocyanate moiety.

As used herein, the term “TAG purity”, “molecular purity”, or “oil purity” refers to the number of molecular species that make up an oil composition, on an absolute basis or present in amounts above a certain threshold. The fewer the number of TAG species in an oil, the greater the “purity” of the oil. In some embodiments, a pure oil can be an oil comprising up to 9 TAG species and 60% of more of triolein. In some embodiments, a pure oil can comprise up to 4 TAG species present in amounts of above a certain threshold in the oil (e.g., excluding trace amounts of other TAG species) and 90% or more of a single TAG species, such as triolein.

As used herein, the term “oleic content” or “olein content” refers the percentage amount of oleic acid in the fatty acid profile of a substance (e.g., a polyol). As used herein, the term “C18:1 content” refers the percentage amount of a C18:1 fatty acid (e.g., oleic acid) in the fatty acid profile of a substance (e.g., a polyol).

As used herein, the term “hydroxyl number” or “OH #” of the resulting polyol refers to the number of milligrams of potassium hydroxide (mg KOH/g) required to neutralize the acetic acid taken up on acetylation of one gram of a substance (e.g., a polyol) that contains free hydroxyl groups. The hydroxyl number is a measure of the content of free hydroxyl groups in the substance. The hydroxyl number can be determined by ASTM E1899.

As used herein, the term “cure time” or “curing time” refers to the amount of time in which chemical crosslinking of a casting is complete and the physical properties of the casting do not change over time, e.g., viscosity, glass transition temperature (T g), impact resistance, strength, or hardness. Curing time can be accelerated by the addition of heat.

As used herein, a plasticizer is a substance that is added to a material to make the material softer and more flexible, thereby increasing plasticity of the material. Plasticizers such as those described herein can be incorporated into cast PU resin formulations to increase impact resistance, while substantially preserving hardness and strength of the resulting cast resin.

As used herein, the term “about” refers to ±10% from the value provided.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are described herein.

### Impact Resistant Biobased Cast Polyurethanes

Biobased cast urethanes having improved impact resistance are described herein. For example, described herein are algal oil polyol based cast urethanes having improved impact resistance. These cast urethane formulations exhibit excellent tensile strength and hardness suitable for use in hard goods applications, particularly at cold temperatures. These biobased cast urethanes can therefore provide a sustainable alternative to other plastics, such as petroleum-based ABS.

Biobased cast urethane formulations generally have lower impact resistance relative to incumbent materials such as ABS. To achieve higher tensile strength (impact resistance) and Shore hardness, short chain, low molecular weight diols (e.g., 1,3-propanediol, 1,4-butanediol, or 1,6-hexanediol) can be incorporated into these formulations to serve as crosslinking agents between isocyanate moieties. However, incorporation of short chain diols can result in rigid, highly crystalline thermoset polyurethane structures. While the hardness of these materials can range widely, these highly crystalline formulations are not truly plastic, thermoset materials. As a consequence, these materials can be brittle, having limited yield and easy breakage.

Additives or modifiers can be incorporated into cast urethane formulations to improve impact resistance. One example are macrodiols, also known as high molecular weight or long chain diols. Macrodiols, containing hydroxyl groups, can participate in the urethane linking, thereby increasing the crosslinking interactions and the strength of the resulting cast urethane material. In some embodiments, a macrodiol disclosed herein has a molecular weight of greater than 500, greater than 1000, or greater than 2000. Non-limiting examples of macrodiols include polybutadiene diols (e.g., Polyvest® HT), polytetrahydrofurans (PolyTHF®), and polycarbonate diols.

Another class of PU strengthening additives are plasticizers. Unlike macrodiols, plasticizers do not participate in the covalent urethane linking. Plasticizers can reduce viscosity of a material by promoting plasticity and flexibility, thereby reducing brittleness of a material. For this reason, plasticizers can increase impact resistance of a material, while decreasing the hardness of the material. Non-limiting examples of plasticizers include pigments, oils (e.g., microbiol oils, algal oils, vegetable oils, epoxidized vegetable oils), polyethylene glycol dibenzoates (e.g., Modulast® PUR), and dialkyl phthalates, like dioctyl phthalate.

### Cast Polyurethane Compositions

In some embodiments, a polyurethane resin described herein contains a biobased polyol; an isocyanate; and a catalyst.

The polyol can be in an amount of about 30% to about 70% on a weight-by-weight basis of the resin. In some embodiments, the polyol is at an amount of about 40% to about 70%, about 40% to about 65%, about 50% to about 70%, or about 50% to about 60% on a weight-by-weight basis of the resin. For example, the polyol is at an amount of about 30%, about 31%, about 32%, about 33%, about 34%, about 35%, about 36%, about 37%, about 38%, about 39%, about 40%, about 41%, about 42%, about 43%, about 44%, about 45%, about 44%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, or about 70% on a weight-by-weight basis of the resin.

In some embodiments, the polyol is derived from a microbial triglyceride oil. In some embodiments, the polyol is derived from an algal triglyceride oil. In some embodiments, the polyol is derived from epoxidized triglyceride oil. In some embodiments, the polyol is derived from epoxidized and ring opened triglyceride oil. In some embodiments, the polyol is derived from hydroformylated triglyceride oil. In some embodiments, the polyol is derived from hydroformylated and hydrogenated triglyceride oil.

In some embodiments, a polyol has a C18:1 content of at least 60%, at least 70%, at least 80%, or at least 90%. For example, a polyol has a C18:1 content of about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or more.

The isocyanate can be in an amount of about 15% to about 60% on a weight-by-weight basis of the resin. In some embodiments, the isocyanate is at an amount of about 20% to about 60%, about 20% to about 50%, about 20% to about 40%, about 25% to about 40%, about 28% to about 38% on a weight-by-weight basis of the resin. For example, the isocyanate is about 25%, about 26%, about 27%, about 28%, about 29%, about 30%, about 31%, about 32%, about 33%, about 34%, about 35%, about 36%, about 37%, about 38%, about 39%, or about 40% on a weight-by-weight basis of the resin.

In some embodiments, the isocyanate is a monomeric isocyanate or a polymeric isocyanate. Non-limiting examples of monomeric isocyanates include Rubinate ° 44 and Rubinate ° 9225. Non-limiting examples of polymeric isocyanates include polymeric methylene diphenyl diisocyanate (MDI) and Rubinate ° M. Non-limiting examples of isocyanates include methylenebis(phenyl isocyanate) (MDI), toluene diisocyanate (TDI), and hexamethylene diisocyanate (HDI), naphthalene diisocyanate (NDI), methylene bis-cyclohexylisocyanate (HMDI)(hydrogenated MDI), and isophorone diisocyanate (IPDI).

The catalyst can be in an amount of about 0.1% to about 2%, about 0.1% to about 1%, about 0.5% to about 0.8%, or about 0.1% to about 0.5% on a weight-by-weight basis of the resin. For example, the catalyst is at an amount of about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, or about 2% on a weight-by-weight basis of the resin.

In some embodiments, the catalyst is an amine catalyst, a primary amine catalyst, a secondary amine catalyst, a tertiary amine catalyst, an organometallic catalyst, an organotin catalyst, an organozinc catalyst, or an organozirconium catalyst. In some embodiments, the catalyst is a tertiary amine catalyst. In some embodiments, the catalyst is 1,4-diazabicyclo[2.2.2]octane (DABCO). In some embodiments, the catalyst is an organotin catalyst. In some embodiments, the catalyst is dibutyltin dilaurate (DBTDL).

Zeolites are hydrated aluminosilicate minerals containing alkali or alkaline metals (e.g., sodium, potassium, calcium, and magnesium) plus water molecules trapped in the gaps between them. The open, cage-like, crystal structure of zeolites allow for trapping of other molecules therein, and thus, are useful as molecular sieves and drying agents. A non-limiting example of zeolites is Molsiv® molecular sieves.

In some embodiments, a polyurethane resin further comprises zeolites at an amount of about 0.1% to about 5% on a weight-by-weight basis of the polyol. For example, the zeolites is an amount of about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, or more on a weight-by-weight basis of the resin.

In some embodiments, a polyurethane resin described herein contains a biobased polyol; a diol having a molecular weight of less than 100 g/mol; an isocyanate; and a catalyst. In some embodiments, a polyurethane resin comprises a diol having a molecular weight of less than 200 g/mol, a molecular weight of less than 500 g/mol, or a molecular weight of less than 1000 g/mol. Non-limiting examples of such diols include 1,3-propanediol; 1,4-butanediol; and 1,6-hexanediol. These low MW diols can be present at an amount of about 1% to about 10% on a weight-by-weight basis of the resin. For example, the low molecular weight diol is an amount of about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, about 8%, about 8.1%, about 8.2%, about 8.3%, about 8.4%, about 8.5%, about 8.6%, about 8.7%, about 8.8%, about 8.9%, about 9%, about 9.1%, about 9.2%, about 9.3%, about 9.4%, about 9.5%, about 9.6%, about 9.7%, about 9.8%, about 9.9%, or about 10% on a weight-by-weight basis of the resin.

In alternative embodiments, a polyurethane resin described herein contains a biobased polyol; a diol having a molecular weight of greater than 100 g/mol; an isocyanate; and a catalyst. In some embodiments, a polyurethane resin comprises a macrodiol having a molecular weight of greater than 500 g/mol, greater than 1000 g/mol, greater than 1500 g/mol, greater than 2000 g/mol, greater than 2500 g/mol, or greater than 3000 g/mol. In some embodiments, a macrodiol disclosed herein has a molecular weight of about 500 g/mol to about 5000 g/mol, about 1000 g/mol to about 3000 g/mol, or about 1000 g/mol to about 5000 g/mol. For example, a macrodiol disclosed herein has a molecular weight of about 1000 g/mol, about 2000 g/mol, or about 2900 g/mol. For example, a macrodiol disclosed herein has a molecular weight of 500 g/mol to 1000 g/mol, 1000 g/mol to 1500 g/mol, 1500 g/mol to 2000 g/mol, 2000 g/mol to 2500 g/mol, 2500 g/mol to 3000 g/mol, 3000 g/mol to 3500 g/mol, or 3500 g/mol to 4000 g/mol. In some embodiments, the macrodiol is a polybutadiene diol, a polytetrahydrofuran, or a polycarbonate diol. In some embodiments, the macrodiol is biobased.

Macrodiols can be present in a cast urethane resin at an amount of about 1% to about 15%, about 1% to about 10%, or about 5% to about 10% on a weight-by-weight basis of the resin. For example, the macrodiol can be present an amount of about 1%, about 2%, about 3%, about 4%, about 5%, about 6%, about 7%, about 8%, about 8%, about 9%, about 10%, about 11%, about 12%, about 13%, about 14%, about 15% on a weight-by-weight basis of the resin.

Cast urethane formulations described herein can be produced by casting into a mold. After casting, the polyurethane resin can be cured at a temperature of from 20° C. to 110° C. or from 20° C. to 25° C., for example, at 20° C., at 25° C., at 30° C., at 35° C., at 40° C., at 45° C., at 50° C., at 55° C., at 60° C., at 65° C., at 70° C., at 75° C., at 80° C., at 85° C., at 90° C., at 100° C., or 110° C. In some embodiments, the cast urethane resin can be cured at room temperature (e.g., about 25° C.). In some embodiments, the cast urethane resin can be cured at room temperature (e.g., about 25° C.) for at least 48 hours. In some embodiments, the cast urethane resin can be cured by heat. In some embodiments, the cast urethane resin can be cured at about 75° C. for at least 30 minutes. In some embodiments, the cast urethane resin can be cured at about 110° C. for at least 15 hours. In some embodiments, the cast urethane resin can be cured at a temperature that is not greater than 25° C. In some embodiments, the cast urethane resin can be cured at a temperature that is not greater than 110° C.

Curing time can affect the physical properties of a cast urethane resin product. In some embodiments, the cast urethane resin can be cured for about 30 minutes to about 4 hours, for example, about 30 minutes, about 45 minutes, about 1 hour, about 1.5 hours, about 2 hours, about 2.5 hours, about 3 hours, about 3.5 hours, or about 4 hours. In some embodiments, the cast urethane resin can be cured for less than 30 minutes.

In some embodiments, the cast urethane resin can be cured for about 16 hours to about 48 hours, for example, about 16 hours, about 17 hours, about 18 hours, about 19 hours, about 20 hours, about 21 hours, about 22 hours, about 23 hours, or about 24 hours. In some embodiments, the polyurethane resin can be cured for longer than 24 hours. In some embodiments, the polyurethane resin can be cured for at least 48 hours.

In some embodiments, the cast urethane resin can be cured at room temperature for a sufficient time to impart optimal mechanical properties, for example, such that one or more properties of the polyurethane resin does not change over time (e.g., T g, strength, flexibility, impact resistance, Shore D hardness). The cured resin exhibits a variety of physical properties based on the method of production. Cast urethane formulations can be characterized by various metrics, including tensile strength, elongation at break, flexural strength, break stress, glass transition temperature, Shore D hardness, and biobased content. Some of these parameters can be assessed at various temperatures dependent upon the application of the cast urethane resin. For example, a cast urethane resin can be assessed at low temperature (e.g., 0-2° C. or −20° C.), room temperature (e.g., about 25° C.), or high temperature.

In some embodiments, impact resistance of a cast urethane resin described herein is assessed by Charpy testing or ASTM D6110. In some embodiments, impact resistance is assessed at room temperature or low temperature (e.g., −20° C.).

In some embodiments, a cast urethane resin described herein has an impact resistance of about 10 kJ/m² to about 200 kJ/m², about 10 kJ/m² to about 150 kJ/m², about 10 kJ/m² to about 50 kJ/m², about 20 kJ/m² to about 40 kJ/m², about 40 kJ/m² to about 60 kJ/m², about 40 kJ/m² to about 80 kJ/m², about 80 kJ/m² to about 120 kJ/m², about 100 kJ/m² to about 150 kJ/m², about 100 kJ/m² to about 200 kJ/m², or about 120 kJ/m² to about 160 kJ/m².

In some embodiments, a cast urethane resin described herein has an impact resistance of greater than 10 kJ/m², greater than 15 kJ/m², greater than 20 kJ/m², greater than 25 kJ/m², greater than 30 kJ/m², greater than 35 kJ/m², greater than 40 kJ/m², greater than 45 kJ/m², greater than 50 kJ/m², greater than 55 kJ/m², greater than 60 kJ/m², greater than 65 kJ/m², greater than 70 kJ/m², greater than 75 kJ/m², greater than 80 kJ/m², greater than 85 kJ/m², greater than 90 kJ/m², greater than 95 kJ/m², greater than 100 kJ/m², greater than 105 kJ/m², greater than 110 kJ/m², greater than 115 kJ/m², greater than 120 kJ/m², greater than 125 kJ/m², greater than 130 kJ/m², greater than 135 kJ/m², greater than 140 kJ/m², greater than 145 kJ/m², greater than 150 kJ/m², greater than 155 kJ/m², greater than 160 kJ/m², greater than 165 kJ/m², greater than 170 kJ/m², greater than 175 kJ/m², greater than 180 kJ/m², or greater than 200 kJ/m².

In some embodiments, a cast urethane resin described herein has an impact resistance of about 10 kJ/m², about 20 kJ/m², about 30 kJ/m², about 40 kJ/m², about 50 kJ/m², about 60 kJ/m², about 70 kJ/m², about 80 kJ/m², about 90 kJ/m², about 100 kJ/m², about 110 kJ/m², about 120 kJ/m², about 130 kJ/m², about 140 kJ/m², about 150 kJ/m², about 160 kJ/m², about 170 kJ/m², about 180 kJ/m², about 190 kJ/m², or about 200 kJ/m².

In some embodiments, Shore D hardness of a cast urethane resin described herein is assessed by durometer hardness testing or ASTM D2240. In some embodiments, Shore D hardness is assessed at room temperature (e.g., 20° C.) or low temperature (e.g., 0-2° C. or 20° C.)

In some embodiments, a cast urethane resin described herein has a Shore D hardness of about 10 to about 100, about 10 to about 80, about 10 to about 50, about 10 to about 40, about 10 to about 30, about 50 to about 100, about 50 to about 80, about 50 to about 70, or about 40 to about 80.

In some embodiments, a cast urethane resin described herein has a Shore D hardness of greater than 20, greater than 30, greater than 40, greater than 50, greater than 60, greater than 70, or greater than 80.

In some embodiments, a cast urethane resin described herein has a Shore D hardness of about 20, about 25, about 30, about 35, about 40, about 45, about 50, about 55, about 60, about 65, about 70, about 75, or about 80.

In some embodiments, a cast urethane resin has a biobased content of about 40% to about 60% as assessed on a weight-by-weight basis. In some embodiments, biobased content of a cast urethane resin can be assessed by ASTM 6866. For example, a polyurethane resin described herein has a biobased content of about 50% to about 60%. For example, a polyurethane resin has a biobased content of at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, or at least 60%. In some embodiments, a polyurethane resin has a biobased content of about 50%, about 51%, about 52%, about 53%, about 54%, about 55%, about 56%, about 57%, about 58%, about 59%, or about 60%.

In some embodiments, a cast urethane resin can be produced in a heated press at a temperature ranging from 50° C. to 100° C., from 50° C. to 60° C., from 60° C. to 70° C., from 70° C. to 80° C., from 80° C. to 90° C., or from 90° C. to 100° C., for example, at about 50° C., at about 60° C., at about 70° C., at about 80° C., at about 90° C., or at about 100° C.

In some embodiments, a cast urethane resin can be produced by application of heat and/or pressure for duration of from about 10 minutes to about 20 minutes, from about 20 minutes to about 30 minutes, from about 30 minutes to about 40 minutes, from about 40 minutes to about 50 minutes, from about 50 minutes to about 70 minutes, for example, about 10 minutes, about 15 minutes, about 20 minutes, about 25 minutes, about 30 minutes, about 35 minutes, about 40 minutes, about 45 minutes, about 50 minutes, about 55 minutes, 60 minutes, about 65 minutes, about 70 minutes, about 75 minutes, about 80 minutes, 85 minutes, 90 minutes, or more.

### Microbial Polyols

Microbial oils described herein can include triglyceride oils derived from a microbe. Microbial oils can be produced using oleaginous microbes. Microbial oil produced by oleaginous microbes has numerous advantages, including improved production efficiency and TAG compositions that can be enhanced for generating polyols. Namely, increasing the levels of unsaturation of TAG compositions can enhance control of the chemistry involved in the generation of polyols. These characteristics of microbial oil result in a greater yield of hydroxyl group functionality relative to oils with greater TAG heterogeneity (lower purity) and/or diversity. Thus, polyols derived from a microbial oil can be preferable in generating polymers, including in instances where physical properties of a polymer can be compromised by molecular impurities, such as non-hydroxylated fatty acids, that can be present in oils having a more diverse and/or heterogeneous TAG profile.

Methods of producing TAG oils from oleaginous microbes can also have reduced carbon footprints than methods of producing TAG oils from cultivation of oilseeds. Further sustainability efforts can be achieved by cultivation of these microbes using energy-efficient sugar cane mills powered by co-generation of sugarcane bagasse.

Polyols derived from a microbial oil can be particularly useful for producing polyurethane materials. For example, microbial oils can comprise relatively low TAG diversity, low fatty acid diversity, and the majority of fatty acids present in the microbial oil can be unsaturated fatty acids. A higher ratio of unsaturated fatty acid to saturated fatty acid allows for increased chemical reactivity at the carbon-carbon double bonds. Microbial oils having low TAG diversity and a high proportion of unsaturated fatty acids can be especially desirable in polyurethane production because hydroxylation of such a mixture yields a greater percentage of fatty acids that can participate in crosslinking reactions with isocyanates. Unlike unsaturated fatty acids, saturated fatty acids do not contain carbon-carbon double bounds and cannot participate in crosslinking reactions with isocyanates. Thus, polyols generated from hydroxylation of unsaturated fatty acids from microbial oil can yield polyurethane materials having superior properties.

In some embodiments, the fatty acid profile of a triglyceride oil described herein comprises at least about 30%, at least about 35%, at least about 40%, at least about 45%, at least about 50%, at least about 55%, at least about 60%, at least about 61%, at least about 62%, at least about 63%, at least about 64%, at least about 65%, at least about 66%, at least about 67%, at least about 68%, at least about 69%, at least about 70%, least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of an unsaturated fatty acid species. Non-limiting examples of unsaturated fatty acid species include of a 16:1 fatty acid, a 16:2 fatty acid, a 16:3 fatty acid, an 18:1 fatty acid, an 18:2 fatty acid, an 18:3 fatty acid, an 18:4 fatty acid, a 20:1 fatty acid, a 20:2 fatty acid, a 20:3 fatty acid, a 22:1 fatty acid, a 22:2 fatty acid, a 22:3 fatty acid, a 24:1 fatty acid, a 24:2 fatty acid, and a 24:3 fatty acid. In some embodiments, the unsaturated fatty acid species is oleic acid.

In some embodiments, the predominant TAG species in a triglyceride oil described herein is 000 or triolein. In some embodiments, the microbial oil comprises at least about 60%, at least about 61%, at least about 62%, at least about 63%, at least about 64%, at least about 65%, at least about 66%, at least about 67%, at least about 68%, at least about 69%, at least about 70%, least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of triolein.

Polyols derived from highly unsaturated oils have high hydroxyl numbers compared to polyols derived from oils having lower saturation levels. High hydroxyl number increases the versatility of a polyol for producing a wide range of polyurethane materials. A polyol described herein can have a hydroxyl number of from 125 to 165, from 145 to 165, from 135 to 160, from 140 to 155, or from 150 to 165. For example, a polyol described herein can have a hydroxyl number of 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, or 165. In some embodiments, the hydroxyl number of a polyol can be determined by ASTM E1899.

In the process of producing natural oil polyols from biobased sources, the hydroxyl functionality can be introduced via chemical conversion of the triglyceride oil. This conversion requires the presence of a carbon-carbon double bond on the acyl moiety of the fatty acid, e.g., an olefinic group, which can be accomplished using several different chemical processes including, for example:
i) Epoxidation in the presence of hydrogen peroxide and an acid catalyst, followed by ring opening with reagents, such as water, hydrogen, methanol, ethanol, propanol, isopropanol, C₁-C₄ carboxylic acids, or other polyols, e.g., acetic acid or formic acid. Ring opening can be facilitated by reaction with an alcohol, including, for example, β-substituted alcohols. These chemistries result in secondary hydroxyl moieties, and are therefore less reactive, for example, with isocyanate or methyl esters.
ii) Ozonolysis by molecular oxygen results in the formation of ozonides, which upon further oxidation results in scission at the double bond and formation of di-acids, carboxylic acids, and upon reduction with hydrogen, formation of aldehydes. Ozonolysis and reduction of oleic acid, for example, produces azaleic acid, pelargonic acid, and pelargonaldehyde, respectively.
iii) Hydroformylation with synthesis gas (syngas), using rhodium or cobalt catalysts to form the aldehyde at the olefinic group, followed by reduction of the aldehyde to alcohol in the presence of hydrogen.

While typically carried out in organic solvent, chemical processes that utilize aqueous systems can improve the sustainability of these chemistries. Of the chemistries described above, only hydroformylation results in the preservation of fatty acid length and formation of primary hydroxyl moieties. Furthermore, only olefinic fatty acids (having double bonds) can be converted to hydroxyl groups by the processes described above. As such, only these olefinic fatty acids can participate in subsequent downstream chemistries that require a hydroxyl group functionality, i.e., reaction with an isocyanate moiety to form a urethane linkage or reaction with methyl esters to form polyesters. Conversely, fully saturated fatty acids that do not contain carbon-carbon double bonds, cannot participate in crosslinking reactions with isocyanates. Hence, saturated fatty acids can compromise the structural integrity and degrade performance of a polymer produced therefrom.

The complexity and physical properties of a triglyceride oil can be evaluated by the fatty acid profile, and the triacylglycerol (TAG) profile. The fatty acid profile is simply a measure of fatty acid composition. The fatty acid profile of a triglyceride oil can be determined by subjecting oils to transesterification to generate fatty acid methyl esters and subsequently quantitating fatty acid type by Gas Chromatography with Flame Ionization Detector (GC-FID).

Additionally, modification of the fatty acid profile of a native oil to increase the concentration of a particular species of monounsaturated or polyunsaturated fatty acids can lead to an overall decrease in the diversity of TAG species in the oil (i.e., an increase in purity of the oil). The net effect is that a higher number of hydroxylated fatty acids and a higher proportion of all TAG species can participate in urethane chemistries. For example, in two cultivars of peanut oil, N-3101 and H4110, oleic acid content was increased from 46% to 80% and total monounsaturated and polyunsaturated fatty acids was increased only subtly, from 77% to 84%, respectively. According to the TAG profile of the resulting oils derived from the two cultivars, approximately 95% of all TAG species are accounted for in just eight regioisomers in cultivar H4110 and 23 regioisomers in cultivar N-3101. Thus, enriching a single TAG species can result in more homogeneous substrates for subsequent chemical manipulations and incorporation into materials.

Oleaginous microbes can refer to species of microbes having oil contents in excess of 20% on a dry cell weight basis. These microbes are uniquely suited for generating highly pure, natural oil polyols with hydroxyl group functionality. Oleaginous microbes have also been proven extremely facile for genetic modification and improvement. These improvements can occur on time scales that are greatly accelerated relative to what can be achieved in higher plant oilseeds. Oleaginous microbes offer tremendous utility in generating large quantities of triglyceride oils in short periods of time. In as little as 48 hours, appreciable oil production of about 30-40% oil (dry cell weight) can be obtained, whereas typical production requires 120 hours or more to achieve 70-80% oil (dry cell weight). Furthermore, because these microbes can be heterotrophically grown using simple sugars, the production of these triglyceride oils can be divorced from the traditional constraints imposed by geography, climate, and season that constrain triglyceride oil production from oilseed crops.

Recombinant DNA techniques can be used to engineer or modify oleaginous microbes to produce triglyceride oils having desired fatty acid profiles and regiospecific or stereospecific profiles. Fatty acid biosynthetic genes, including, for example, those encoding stearoyl-ACP desaturase, delta-12 fatty acid desaturase, acyl-ACP thioesterase, ketoacyl-ACP synthase, and lysophosphatidic acid acyltransferase can be manipulated to increase or decrease expression levels and thereby biosynthetic activity. These genetically engineered microbes can produce oils having enhanced oxidative, or thermal stability, rendering a sustainable feedstock source for various chemical processes. The fatty acid profile of the oils can be enriched in midchain profiles or the oil can be enriched in triglycerides having specific saturation or unsaturation contents. WO2010/063031, WO2010/120923, WO2012/061647, WO2012/106560, WO2013/082186, WO2013/158938, WO2014/176515, WO2015/051319, and Lin et al. (2013) Bioengineered, 4:292-304, and Shi and Zhao. (2017) Front. Microbiol., 8: 2185 each discloses microbe genetic engineering techniques for oil production.

Among microalgae, several genera and species are particularly suitable for producing triglyceride oils that can be converted to polyols including, but not limited to, Chlorella sp., Pseudochlorella sp., Prototheca sp., Arthrospira sp., Euglena sp., Nannochloropsis sp. Phaeodactylum sp., Chlamydomonas sp., Scenedesmus sp., Ostreococcus sp., Selenastrum sp., Haematococcus sp., Nitzschia, Dunaliella, Navicula sp., Pseudotrebouxia sp., Heterochlorella sp., Trebouxia sp., Vavicula sp., Bracteococcus sp., Gomphonema sp., Watanabea sp., Botryococcus sp., Tetraselmis sp., and Isochrysis sp.

Among oleaginous yeasts, several genera are particularly suitable for producing triglyceride oils that can be converted to polyols including, but not limited to, Candida sp., Cryptococcus sp., Debaromyces sp., Endomycopsis sp., Geotrichum sp., Hyphopichia sp., Lipomyces sp., Pichia sp., Rodosporidium sp., Rhodotorula sp., Sporobolomyces sp., Starmerella sp., Torulaspora sp., Trichosporon sp., Wickerhamomyces sp., Yarrowia sp., and Zygoascus sp.

Among oleaginous bacteria there are several genera and species which are particularly suited to producing triglyceride oils that can be converted to polyols including, but not limited to Flavimonas oryzihabitans, Pseudomonas aeruginosa, Morococcus sp., Rhodobacter sphaeroides, Rhodococcus opacus, Rhodococcus erythropolis, Streptomyces jeddahensis, Ochrobactrum sp., Arthrobacter sp., Nocardia sp., Mycobacteria sp., Gordonia sp., Catenisphaera sp., and Dietzia sp.

Oleaginous microbes can be cultivated in a bioreactor or fermenter. For example, heterotrophic oleaginous microbes can be cultivated on a sugar-containing nutrient broth.

Oleaginous microbes produce microbial oil comprising triacylglycerides or triacylglycerols. These TAGs can be stored in storage bodies of the cell. A raw oil can be obtained from microbes by disrupting the cells and isolating the oil. WO2008/151149, WO2010/06032, WO2011/150410, WO2012/061647, and WO2012/106560 each discloses heterotrophic cultivation and oil isolation techniques, each of which is entirely incorporated herein by reference. For example, microbial oil can be obtained by cultivating, drying, and pressing the cells. Microbial oils produced can be refined, bleached, and deodorized (RBD) as described in WO2010/120939, which is entirely incorporated herein by reference. In some cases, microbial oils can be obtained without further enrichment of one or more fatty acids or triglycerides with respect to other fatty acids or triglycerides in the raw oil composition.

### Cast Polyurethane Applications

Biobased cast urethanes described herein can have applications in various end products that can require high impact resistance and strength. End products that require high impact resistance include hard goods, such as automotive parts, electronic goods, consumer products, e.g., sporting goods equipment. Non-limiting examples of sporting goods equipment include skis, snowboards, splitboards, skateboards, surfboards, paddleboards, wakeboards, and kiteboards.

Typically, ski sidewall materials are composed of ABS (acrylonitrile butadiene styrene), UHMWPE (ultra-high molecular weight polyethylene), or HDPE (high density polyethylene). However, petroleum-based ABS materials are environmentally unsustainable. Replacement of these unsustainable materials with a biobased, cast PU material derived from renewable materials offers an improvement of conventional polyurethane production methods.

With an increasing awareness of sustainability and the consequences of global warming and the failure to address global climate change and greenhouse gas emissions, materials with high renewable/bio carbon content, such as those described herein, are increasingly sought after, including for use in components of consumer products. Non-limiting examples of such products, including parts and components thereof, are described below. The products can be of any color, any shape, and any size. Non-limiting examples of such products include record albums (including 33⅓, 45, and 72 rpm), kitchen utensil handles/grips (including knives, forks, and spoons, sporting knives, hunting knives, handheld tools and appliances, including shovels, rakes, trowels, ice scrapers, brushes, and power tools, counter or tabletops), home appliance assemblies (including bodies and internal parts for vacuum cleaners, radios, sound systems, blenders, ovens, cabinets, refrigerators/freezers, dishwashers, washers, dryers, toilet seats and toilet seat covers), building blocks used for play or hobby, for example, LEGO® or Duplo® bricks type of any size, e.g., studs or pips (e.g., round plates), plates (e.g., thin LEGO® parts, 3.2 mm high), jumper plates (e.g., a part that allows the half-stud offset to happen), bricks (e.g., any LEGO® piece that is at least 3 plates high on one end and of any shape including round, trapezoidal, triangular, etc.) containing studs and anti-studs (e.g., the indentation underneath most bricks, plates, and tiles that connect with the studs to form the interlocking system of a LEGO® part), baseplates (e.g., those that provide a platform to build on and have are no anti-studs), tiles (e.g., parts having the same height as plates, but do not contain studs on top to provide a smooth finish), figurines or dolls for play or hobby, scale model parts as used by hobbyists, car parts (including any components used in automotive interiors such as dashboard assemblies and components, knobs and dials for sound systems, floor mats, ventilation louvres, door panels, instrument clusters, parts used in automotive exteriors including truck bed liners, mudflaps, bumpers, hood ornaments, plow blades, grill ornaments or grill assemblies, bushings, motor mounts), electronic potting or conformal coating materials used in automotive, appliance, aircraft, ship, communications, aerospace, or other end use applications.

Cast urethanes described herein can also be fashioned to serve as jewelry as a single material or in combination with other materials. Types of jewelry and wearable accessories include necklaces, rings, earrings, eyewear, bracelets, wrist bands, and bangles.

Cast urethanes described herein can be used to make wheels, rollers, balls, gears, and casters, including for recreation, transportation, or conveyance. These products can be for use with skateboards, roller-skates, inline skates, suitcases, luggage, shopping carts, baby strollers, chairs, carts, and dollies. Urethane parts can also be used in material handling, mobility, and conveyance, including in industrial settings and industrial robots.

Cast urethanes described herein can also be used in home and office items, including shelving, containers, cases, drawers, picture frames, trays, boxes, pots, and the like.

Cast urethanes described herein can also be used in tools and objects used in design, drafting, art, or measurement including rulers, mixing sticks, levels, clips, and caps.

Cast urethanes described herein can also be used in overmoldings, cases, fixtures, switches, tiles, and caps for electronic devices such as clocks, lights, alarms, phones, mobile phones, tablets, coffee makers, cameras, earphones, computers, robots, vacuums, and keyboards.

Cast urethanes described herein can also be used in objects for recreation or outdoor sports. For example, cast urethanes can be fashioned into fins for use in surfing or kite boarding. Cast urethanes described herein can be used in construction of bowling balls, golf balls, helmets, rock climbing holds, dumbbell grips, kettlebell grips, children's or pet toys, or in handles and grips for racquets and mallets.

Cast urethanes described herein can also be incorporated into parts of footwear, e.g., in the heel or sole of a shoe.

Cast urethanes described herein have vast utility in industrial applications as well, for example, in non-pneumatic tires, air hoses, bushings for bump stops, body mounts, ladder mitts, nozzles, belting, torque arms, control arms, hydraulic presses, automation machinery, suction cups, sleeves, rings, material handling solutions, hydraulic motors and pumps, and trailing arms. Scrapers and blades for squeegees, plowing blades for snowplows, and conveyor belt wipers. Used in absorbance of vibration, including in grommets, pads, dampers, bumpers, bushings, sheets, rings, and hemispheres.

### EXAMPLES

### Example 1. Cast Urethane Formulations Utilizing Algal Oil Derived Polyols with Improved Impact Resistance

A slow-cured algal oil polyol (AO polyol) cast urethane base formulation (SC) was used as a control. The base formulation comprised of a B-side (polyol) chemistry including AO polyol, 1,4-butanediol, zeolites (Molsiv®), catalyst (DABCO; triethylene diamine), and pigment. Each of the amounts of the 1,4-butanediol, zeolites, and catalyst used was relative to the polyol components in the B-side chemistry on a weight-by-weight (wt/wt) basis. The AO polyol was produced from epoxidation and ethanol ring opening of a high oleic RBD algal oil (>90% C18:1; AlgaPur® HSHO Algae Oil; Corbion®). The zeolites component was prepared by combining 1 part AO polyol with 1 part of UOP L Powder (a potassium calcium sodium aluminosilicate of the zeolite A type with a pore size of approximately 3 Å; A.B. Colby, Inc.) on a weight-by-weight basis to produce a paste. The A-side chemistry was comprised of the isocyanate (polymeric MDI). An amount of the B-side components can be added to the A-side to form an iso-prepolymer. Formation of an iso-prepolymer can allow for preparation of cast PU kits, which involve the mixture of integer volumetric ratios of the B-side and A-side components.

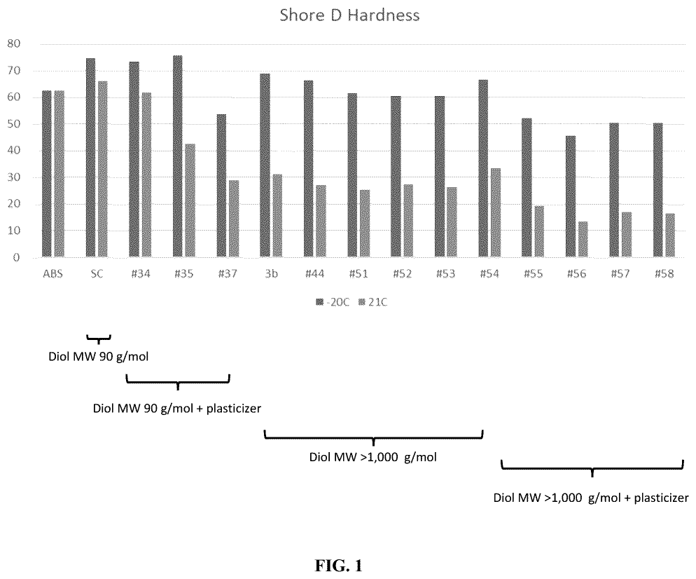

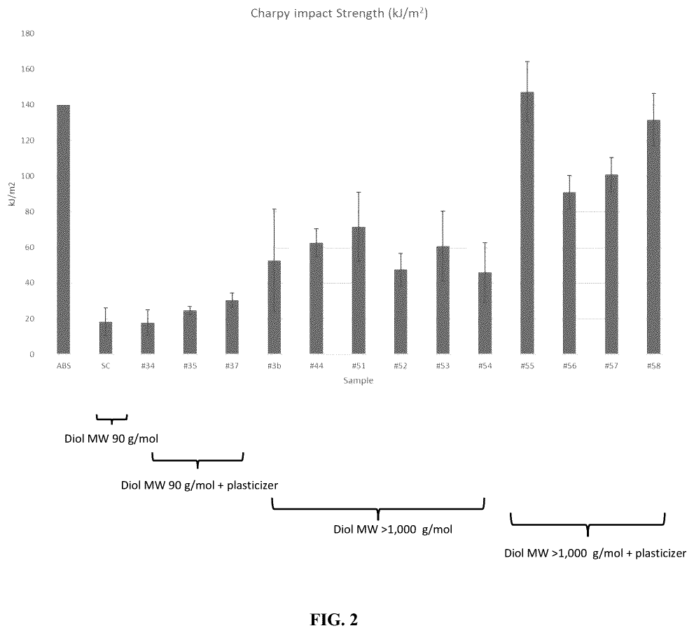

Various additives were incorporated into the base formulation to improve impact resistance, while substantially preserving Shore D hardness. First, the addition of plasticizers modestly improved the impact resistance of these materials (increase of 67%; see slow cure formulation (SC) versus #37 in FIG. 2). Second, the replacement of short chain monomeric diols with long chain monomeric diols (i.e., MW 1000-2900) resulted in a greater increase in impact resistance (increase of 294%; see formulation SC versus #51 in FIG. 2). Finally, the addition of both high MW diols (i.e., MW 1000-2900) and plasticizers resulted in the most significant increase in impact resistance (increase of 711%; see SC versus #55 in FIG. 2). These improvements in impact resistance were accompanied by relatively modest reductions in Shore D hardness, particularly at lower temperatures (FIG. 1). The resultant properties of these formulations make them particularly attractive for cold weather applications.

Polyurethanes were formulated as outlined in TABLE 1. B-side chemistries were formulated to assess the replacement of 1,4-butanediol (1,4-BDO) with a variety of additives to improve impact resistance as determined by the Charpy (un-notched) test. In all formulations, pigment (BJB® yellow) was added at an amount of 2% (wt/wt) of the final formulation as well as through the incorporation of the plasticizer(s). Polyvest® HT (hydroxyl-terminated liquid polybutadienes) (Evonik®) had a MW of 2000 and an OH #47.5. Poly(tetrahydrofurans) (Aldrich Chemical®) of MWs 1000, 2000, and 2900 had OH #s of 115.3, 55, and 37.5, respectively. Plasticizers used in these examples included Modulast® PUR (Emerald Kalma Chemical®); RBD algal oil (≥90% C18:1; AlgaPūr® HSHO Algae Oil; Corbion®); and epoxidized algal oil (Checkerspot®, % Epoxidized Oil Content>4.9). The RBD algal oil is an algal TAG oil. The RBD algal oil is used as feedstock to produce the AO polyol described in the examples herein. The epoxidized algal oil is produced by epoxidation of the RBD algal oil. Since plasticizers do not participate in the urethane chemistry, plasticizers can be added to either the A-side or the B-side. In the examples described herein, the plasticizer is added in the B-side.

TABLE 1

| | FORMULATION | | | | | | |
|---|---|---|---|---|---|---|---|
| Component | SC | 3b | 34 | 35 | 37 | 44 | 51 |
| AO Polyol | 315.91 | 368.56 | 315.91 | 315.91 | 315.91 | 315.91 | 284.32 |
| 1,4-BDO | 32.09 | 0.00 | 31.59 | 31.59 | 31.59 | 0.00 | 0.00 |
| Polyvest ® HT | 0.00 | 36.86 | 0.00 | 0.00 | 0.00 | 31.59 | 31.59 |
| (polybutadiene diol) | | | | | | | |
| Poly(tetrahydrofuran) | 0.00 | 0.00 | 0.00 | 0.00 | 0.00 | 0.00 | 0.00 |
| MW 1000 | | | | | | | |
| Poly(tetrahydrofuran) | 0.00 | 0.00 | 0.00 | 0.00 | 0.00 | 31.59 | 31.59 |
| MW 2000 | | | | | | | |
| Poly(tetrahydrofuran) | 0.00 | 0.00 | 0.00 | 0.00 | 0.00 | 0.00 | 0.00 |
| MW 2900 | | | | | | | |
| Molsive ® | 16.48 | 18.81 | 16.12 | 16.12 | 16.12 | 16.12 | 16.12 |
| DABCO | 0.53 | 0.62 | 0.53 | 0.53 | 0.53 | 0.53 | 0.53 |
| Pigment | 12.5 | 11.72 | 10.04 | 10.04 | 10.04 | 10.56 | 9.69 |
| Modulast ® PUR | 0.00 | 0.00 | 29.91 | 89.73 | 119.64 | 0.00 | 0.00 |
| (polyethylene | | | | | | | |
| glycol dibenzoate) | | | | | | | |
| RBD Algal Oil | 0.00 | 0.00 | 0.00 | 0.00 | 0.00 | 0.00 | 0.00 |
| Epoxidized Algal Oil | 0.00 | 0.00 | 0.00 | 0.00 | 0.00 | 0.00 | 0.00 |
| Dioctyl Phthalate | 0.00 | 0.00 | 0.00 | 0.00 | 0.00 | 0.00 | 0.00 |
| Iso-polymeric MDI | 228.27 | 149.25 | 223.91 | 223.91 | 223.91 | 132.34 | 120.24 |
| Total Wt (g) | 605.78 | 585.82 | 628.01 | 687.83 | 717.74 | 538.64 | 494.08 |
| | FORMULATION | | | | | | |
| Component | 52 | 53 | 54 | 55 | 56 | 57 | 58 |
| AO Polyol | 315.91 | 315.91 | 315.91 | 315.91 | 315.91 | 315.91 | 315.91 |
| 1,4-BDO | 0.00 | 0.00 | 0.00 | 0.00 | 0.00 | 0.00 | 0.00 |
| Polyvest ® HT | 31.59 | 31.59 | 15.80 | 31.59 | 31.59 | 31.59 | 31.59 |
| (polybutadiene diol) | | | | | | | |
| Poly(tetrahydrofuran) | 31.59 | 0.00 | 0.00 | 0.00 | 0.00 | 0.00 | 0.00 |
| MW 1000 | | | | | | | |
| Poly(tetrahydrofuran) | 0.00 | 0.00 | 15.80 | 0.00 | 0.00 | 0.00 | 0.00 |
| MW 2000 | | | | | | | |
| Poly(tetrahydrofuran) | 0.00 | 31.59 | 0.00 | 0.00 | 0.00 | 0.00 | 0.00 |
| MW 2900 | | | | | | | |
| Molsive ® | 16.12 | 16.12 | 16.12 | 16.12 | 16.12 | 16.12 | 16.12 |
| DABCO | 0.53 | 0.53 | 0.53 | 0.53 | 0.53 | 0.53 | 0.53 |
| Pigment | 10.66 | 10.53 | 9.85 | 11.35 | 11.35 | 11.35 | 11.35 |
| Modulast ® PUR | 0.00 | 0.00 | 0.00 | 75.60 | 0.00 | 0.00 | 0.00 |
| (polyethylene | | | | | | | |
| glycol dibenzoate) | | | | | | | |
| RBD Algal Oil | 0.00 | 0.00 | 0.00 | 0.00 | 75.60 | 0.00 | 0.00 |
| Epoxidized Algal Oil | 0.00 | 0.00 | 0.00 | 0.00 | 0.00 | 75.60 | 0.00 |
| Dioctyl Phthalate | 0.00 | 0.00 | 0.00 | 0.00 | 0.00 | 0.00 | 75.60 |
| Iso-polymeric MDI | 137.09 | 130.94 | 128.23 | 127.93 | 127.93 | 127.93 | 127.93 |
| Total Wt (g) | 543.49 | 537.21 | 502.24 | 579.03 | 579.03 | 579.03 | 579.03 |

Coupons for Shore D hardness testing and Charpy impact resistance testing were cast as follows. B-side chemistry components were thoroughly mixed with a paddle mixer until well blended. B-side components were then combined with A-side chemistry components and mixed to completion. The formulations were then degassed under vacuum (25 in Hg) for about 3 min and then poured into a mold having dimensions of 120 mm (L)×120 mm (W)×9.75 mm (D). The mold was heated to 75° C. for 30 minutes and allowed to cool overnight. Coupons for testing were machined from larger casts to final dimensions of 120 mm (L)×11.5 mm (W)×9.75 mm (D) Non-destructive durometer testing was carried out on samples at either 21° C. or −20° C. Ail impact resistance testing was carried out in samples that had been pre-chilled to −20° C. overnight and utilized ASTM D6110.

FIG. 1 shows the results of durometer testing of coupons. ABS (Isosport®) is used as a reference. As shown in FIG. 1, the Shore D hardness of the low MW diol (90 g/mol) base formulation (SC) was 74.67 at −20° C. The Shore D hardness of the low MW diol base formulations concomitant with a polyethylene glycol dibenzoate plasticizer (#34, #35, and #37) was 73.20, 75.70, and 75.70 at −20° C., respectively. The Shore D hardness of the formulations in which low MW diol was replaced with higher MW diols without the addition of plasticizers (#3b, #44, #51-54) was 68.83, 66.17, 61.40, 60.50, 60.40, and 66.50 at −20° C., respectively. The Shore D hardness of the higher MW diol formulations concomitant with addition of plasticizers (#55-58) was 52.10, 45.50, 50.30, and 50.20 at −20° C., respectively. Values are presented in TABLE 2.

TABLE 2

| | Temperature | |
|---|---|---|
| Sample | −20° C. | 21° C. |
| ABS | 62.50 | 62.50 |
| SC | 74.67 | 66.00 |
| #34 | 73.20 | 61.80 |
| #35 | 75.70 | 42.50 |
| #37 | 53.70 | 28.80 |
| #3b | 68.83 | 31.17 |
| #44 | 66.17 | 27.17 |
| #51 | 61.40 | 25.40 |
| #52 | 60.50 | 27.40 |
| #53 | 60.40 | 26.25 |
| #54 | 66.50 | 33.50 |
| #55 | 52.10 | 19.10 |
| #56 | 45.50 | 13.40 |
| #57 | 50.30 | 16.90 |
| #58 | 50.20 | 16.40 |

FIG. 2 shows the results of Charpy testing of coupons at −20° C. ABS (Isosport®) is used as a reference. As shown in FIG. 2, the impact resistance of the low MW diol (90 g/mol) base formulation (SC) was 18.16 kJ/m². The impact resistance of low MW diol base formulations and plasticizer (#34, #35, and #37) was 17.50 kJ/m², 24.50 kJ/m², and 30.40 kJ/m², respectively. The impact resistance of the formulations in which low MW diol was replaced with higher MW diols without the addition of plasticizers (#3b, #44, #51-54) was 52.64 kJ/m², 62.59 kJ/m², 71.55 kJ/m², 47.48 kJ/m², 60.60 kJ/m², and 45.78 kJ/m², respectively. The impact resistance of the higher MW diol formulations concomitant with addition of plasticizers (#55-58) was 147.32 kJ/m², 90.85 kJ/m², 100.76 kJ/m², and 131.60 kJ/m², respectively. Values are presented in TABLE 3. TABLE 3 also provides the biobased content of the formulation on a weight-by-weight basis of the total formulation.

TABLE 3

| | Charpy | |
|---|---|---|
| | Impact | Biobased |
| Material | (kJ/m²) | Content % |
| ABS | 139.97 | — |
| SC | 18.16 | 53.51 |
| #34 | 17.50 | 51.59 |
| #35 | 24.50 | 47.10 |
| #37 | 30.40 | 45.14 |
| #3b | 52.64 | 70.81 |
| #44 | 62.59 | 66.01 |
| #51 | 71.55 | 65.57 |
| #52 | 47.48 | 65.42 |
| #53 | 60.60 | 66.19 |
| #54 | 45.78 | 67.65 |
| #55 | 147.32 | 61.41 |
| #56 | 90.85 | 74.46 |
| #57 | 100.76 | 74.46 |
| #58 | 131.60 | 61.41 |

The most significant improvements in impact resistance were observed for the materials formulated with higher MW diols in combination with the addition of plasticizers (formulations #55-58). Generally, improved impact resistance of the materials attributed to the additive was accompanied by reduced Shore D hardness values. The effect of additives on the base formulation (SC) in regard to Shore D hardness was less pronounced under cold conditions, whereas more significant reductions were observed at room temperature. Improving impact resistance while maintaining Shore D hardness can be particularly desirable for winter sports or cold weather applications.

### Example 2. Cast Urethane Formulations Utilizing Algal Oil Derived Polyols with Improved Impact Resistance

The slow-cured algal oil polyol (AO polyol) cast urethane base formulation (SC) from Example 1 was used as a control. The base formulation comprised of a B-side (polyol) chemistry including AO polyol, 1,4-butanediol, polybutadienediol (Polyvest® HT), zeolites (Molsiv®), catalyst (DABCO; triethylene diamine), and pigment. Each of the amounts of the 1,4-butanediol, zeolites, and catalyst used was relative to the polyol components in the B-side chemistry. The A-side chemistry was comprised of the isocyanate (polymeric MDI).

RBD algal oil was incorporated as a plasticizer component to the base formulation to improve impact resistance, while preserving Shore D hardness. Polyurethanes were formulated as outlined in TABLE 4. In each of the formulations, pigment (BJB® yellow) was added at an amount of 2% (wt/wt) of the final formulation as well as through the incorporation of the one or more plasticizers. Polyvest® HT (hydroxyl-terminated liquid polybutadienes) (Evonik®) had a MW of 2000 and an OH #47.5.

The utilization of RBD algal oil as a plasticizer improved impact resistance as determined by un-notched Charpy testing, while preserving hardness (Shore D hardness) as summarized in TABLE 5. Charpy testing was assessed at low temperature −9 to −17° C. Shore D hardness was assessed at room temperature (RT) and low temperature −9 to −17° C. Algal oil based plasticizers can be preferable for formulating cast PU end products over petroleum-based plasticizers (e.g., ABS). For example, petroleum-based plasticizers tend to have bonding issues with epoxies in ski layups made from algal oil-based products, which is not observed with algal oil based plasticizers. TABLE 5 also provides the biobased content of the formulation on a weight-by-weight basis of the total formulation.

TABLE 4

| | FORMULATION | | | | | | | |
|---|---|---|---|---|---|---|---|---|
| Component | SC | 4 | 61 | 62 | 63 | 64 | 65 | 66 |
| AO Polyol | 315.91 | 309 | 315.91 | 315.91 | 315.91 | 315.91 | 315.91 | 315.91 |
| 1,4-BDO | 32.09 | 15.81 | 0 | 0 | 31.39 | 31.39 | 31.39 | 15.7 |
| Polyvest ® HT | 0 | 15.81 | 31.59 | 31.59 | 0 | 0 | 0 | 15.7 |
| PolyTHF | 0 | 0 | 0 | 0 | 0 | 0 | 0 | 0 |
| MW 1000 | | | | | | | | |
| PolyTHF | 0 | 0 | 0 | 0 | 0 | 0 | 0 | 0 |
| MW 2000 | | | | | | | | |
| PolyTHF | 0 | 0 | 0 | 0 | 0 | 0 | 0 | 0 |
| MW 2900 | | | | | | | | |
| Molsiv ® | 16.48 | 15.82 | 16.12 | 16.12 | 16.12 | 16.12 | 16.12 | 16.12 |
| DABCO | 0.53 | 1.06 | 0.53 | 0.53 | 0.53 | 0.53 | 0.53 | 0.53 |
| Pigment | 12.5 | 10.62 | 10.85 | 10.35 | 13.54 | 12.94 | 12.34 | 12.45 |
| Modulast ® PUR | 0 | 0 | 0 | 0 | 0 | 0 | 0 | 0 |
| RBD Algal Oil | 0 | 0 | 50.4 | 25.2 | 90 | 60 | 30 | 82.8 |
| Epoxidized Algal Oil | 0 | 0 | 0 | 0 | 0 | 0 | 0 | 0 |
| Dioctyl Phthalate | 0 | 0 | 0 | 0 | 0 | 0 | 0 | 0 |
| Iso-polymeric MDI | 228.27 | 173.27 | 127.93 | 127.93 | 223.28 | 223.28 | 223.28 | 175.59 |
| Total Wt (g) | 605.78 | 541.39 | 553.33 | 527.63 | 690.77 | 660.17 | 629.57 | 634.79 |
| | FORMULATION | | | | | | | |
| Component | 67 | 68 | 69 | 70 | 71 | 72 | 80 | 88 |
| AO Polyol | 315.91 | 315.91 | 315.91 | 315.91 | 315.91 | 315.91 | 309 | 318.43 |
| 1,4-BDO | 15.7 | 15.7 | 0 | 0 | 0 | 15.7 | 15.81 | 7.97 |
| Polyvest ® HT | 15.7 | 15.7 | 31.59 | 31.59 | 31.59 | 15.7 | 15.81 | 23.90 |
| PolyTHF | 0 | 0 | 0 | 0 | 0 | 0 | 0 | 0 |
| MW 1000 | | | | | | | | |
| PolyTHF | 0 | 0 | 0 | 0 | 0 | 0 | 0 | 0 |
| MW 2000 | | | | | | | | |
| PolyTHF | 0 | 0 | 0 | 0 | 0 | 0 | 0 | 0 |
| MW 2900 | | | | | | | | |
| Molsiv ® | 16.12 | 16.12 | 16.12 | 16.12 | 16.12 | 16.12 | 15.82 | 16.25 |
| DABCO | 0.53 | 0.53 | 0.53 | 0.53 | 0.53 | 0.53 | 1.06 | 0.53 |
| Pigment | 11.89 | 11.34 | 11.34 | 11.09 | 11.21 | 12.74 | 10.62 | 10.64 |
| Modulast ® PUR | 0 | 0 | 0 | 0 | 0 | 0 | 0 | 0 |
| RBD Algal Oil | 55.2 | 27.6 | 55.92 | 62.22 | 68.64 | 97.5 | 34.55 | 13.77 |
| Epoxidized Algal Oil | 0 | 0 | 0 | 0 | 0 | 0 | 0 | 0 |
| Dioctyl Phthalate | 0 | 0 | 0 | 0 | 0 | 0 | 0 | 0 |
| Iso-polymeric MDI | 175.59 | 175.59 | 127.93 | 127.93 | 127.93 | 175.59 | 173.27 | 153.17 |
| Total Wt (g) | 606.63 | 578.48 | 559.34 | 565.39 | 571.93 | 649.79 | 541.39 | 544.67 |

TABLE 5

| | | | Charpy | Charpy | Biobased |
|---|---|---|---|---|---|
| Material | | | Impact | Impact | Content |
| Temper- | Shore D Hardness | | (kJ/m²) | STDEV | (%) |
| ature | RT | −9 to −17° C. | −9 to −17° C. | — | — |
| ABS | 62.5 | 62.5 | 139.97 | — | — |
| SC | 67.50 | 79.00 | 18.16 | 7.88 | 61.46 |
| #4 | 31.00 | 76.00 | 8.40 | 1.48 | 61.46 |
| #61 | 16.80 | 48.10 | 66.20 | 17.72 | 73.37 |
| #62 | 19.50 | 58.90 | 63.29 | 8.27 | 72.16 |
| #63 | 24.10 | 56.50 | 14.59 | 7.32 | 59.93 |
| #64 | 26.50 | 62.60 | 23.13 | 2.53 | 58.16 |
| #65 | 36.20 | 66.90 | 24.09 | 4.25 | 56.22 |
| #66 | 14.90 | 47.30 | 60.78 | 10.08 | 66.55 |
| #67 | 20.20 | 57.50 | 37.51 | 1.60 | 65.09 |
| #68 | 28.90 | 66.13 | 27.28 | 4.93 | 63.49 |
| #69 | 17.75 | 50.50 | 72.53 | 12.04 | 73.57 |
| #70 | 18.60 | 57.20 | 78.06 | 23.31 | 73.89 |
| #71 | 18.40 | 49.60 | 92.20 | 8.24 | 74.17 |
| #72 | 20.50 | 57.30 | 32.17 | 22.39 | 67.28 |
| #80 | 46 | 69 | 45.5 | 4.87 | 63.77 |
| #88 | 51 | 72.5 | 138.77 | 28.47 | 66.87 |

### EMBODIMENTS

Embodiment 1. A reaction mixture comprising:
a) a biobased polyol at an amount of about 30% to about 70% on a weight-by-weight basis of the reaction mixture;
b) an isocyanate at an amount of about 15% to about 60% on a weight-by-weight basis of the reaction mixture;
c) a catalyst at an amount of about 0.1% to about 2% on a weight-by-weight basis of the reaction mixture;
d) a zeolite at an amount of about 0.1% to about 5% on a weight-by-weight basis of the reaction mixture; and
e) one or more macrodiols at an amount of about 1% to about 15% on a weight-by-weight basis of the reaction mixture.

Embodiment 2. The reaction mixture of embodiment 1, wherein the biobased polyol is at an amount of about 40% to about 65% on a weight-by-weight basis of the reaction mixture.

Embodiment 3. The reaction mixture of embodiment 1 or 2, wherein the biobased polyol is a TAG polyol.

Embodiment 4. The reaction mixture of any one of embodiments 1-3, wherein the biobased polyol is derived from a microbial triglyceride oil.

Embodiment 5. The reaction mixture of any one of embodiments 1-3, wherein the biobased polyol is derived from an algal triglyceride oil.

Embodiment 6. The reaction mixture of any one of embodiments 1-5, wherein the biobased polyol is derived from epoxidation and ring opening of a biobased triglyceride oil.

Embodiment 7. The reaction mixture of any one of embodiments 1-6, wherein the biobased polyol has an oleic acid content of greater than 60%.

Embodiment 8. The reaction mixture of any one of embodiments 1-6, wherein the biobased polyol has an oleic acid content of greater than 80%.

Embodiment 9. The reaction mixture of any one of embodiments 1-6, wherein the biobased polyol has an oleic acid content of greater than 90%.

Embodiment 10. The reaction mixture of any one of embodiments 1-9, wherein the biobased polyol has a hydroxyl number of 150 to 165.

Embodiment 11. The reaction mixture of any one of embodiments 1-10, wherein the isocyanate is at an amount of about 20% to about 40% on a weight-by-weight basis of the reaction mixture.

Embodiment 12. The reaction mixture of any one of embodiments 1-11, wherein the isocyanate is a polymeric isocyanate.

Embodiment 13. The reaction mixture of any one of embodiments 1-12, wherein the catalyst is at an amount of about 0.1% to about 0.5% on a weight-by-weight basis of the polyol.

Embodiment 14. The reaction mixture of any one of embodiments 1-12, wherein the catalyst is at an amount of about 1% on a weight-by-weight basis of the reaction mixture.

Embodiment 15. The reaction mixture of any one of embodiments 1-14, wherein the catalyst is an amine catalyst.

Embodiment 16. The reaction mixture of any one of embodiments 1-14, wherein the catalyst is 1,4-diazabicyclo[2.2.2]octane (DABCO).

Embodiment 17. The reaction mixture of any one of embodiments 1-14, wherein the catalyst is an organometallic catalyst.

Embodiment 18. The reaction mixture of any one of embodiments 1-14, wherein the catalyst is an organotin catalyst, an organozinc catalyst, or an organozirconium catalyst.

Embodiment 19. The reaction mixture of any one of embodiments 1-14, wherein the catalyst is an organotin catalyst.

Embodiment 20. The reaction mixture of any one of embodiments 1-14, wherein the catalyst is dibutyltin dilaurate (DBTDL).

Embodiment 21. The reaction mixture of any one of embodiments 1-20, wherein the zeolite is at an amount of about 1% to about 5% on a weight-by-weight basis of the reaction mixture.

Embodiment 22. The reaction mixture of any one of embodiments 1-21, wherein the one or more macrodiols is at an amount of about 1% to about 10% on a weight-by-weight basis of the reaction mixture.

Embodiment 23. The reaction mixture of any one of embodiments 1-21, wherein the one or more macrodiols is at an amount of about 5% to about 10% on a weight-by-weight basis of the reaction mixture.

Embodiment 24. The reaction mixture of any one of embodiments 1-23, wherein the one or more macrodiols has a molecular weight of greater than 500.

Embodiment 25. The reaction mixture of any one of embodiments 1-23, wherein the one or more macrodiols has a molecular weight of greater than 1000.

Embodiment 26. The reaction mixture of any one of embodiments 1-23, wherein the one or more macrodiols has a molecular weight of greater than 2000.

Embodiment 27. The reaction mixture of any one of embodiments 1-26, wherein the one or more macrodiols is a polybutadiene diol.

Embodiment 28. The reaction mixture of any one of embodiments 1-26, wherein the one or more macrodiols is a polytetrahydrofuran.

Embodiment 29. The reaction mixture of any one of embodiments 1-26, wherein the one or more macrodiols is a polybutadiene diol and a polytetrahydrofuran.

Embodiment 30. The reaction mixture of any one of embodiments 1-29, wherein the one or more macrodiols is a biobased macrodiol.

Embodiment 31. The reaction mixture of any one of embodiments 1-30, further comprising an additive at an amount of about 1% to about 30%.

Embodiment 32. The reaction mixture of any one of embodiments 1-30, further comprising an additive at an amount of about 1% to about 20%.

Embodiment 33. The reaction mixture of embodiment 31 or 32, wherein the additive is a plasticizer.

Embodiment 34. The reaction mixture of embodiment 33, wherein the plasticizer is a biobased plasticizer.

Embodiment 35. The reaction mixture of embodiment 33, wherein the plasticizer is a vegetable oil.

Embodiment 36. The reaction mixture of embodiment 33, wherein the plasticizer is a microbial oil.

Embodiment 37. The reaction mixture of embodiment 33, wherein the plasticizer is an algal oil.

Embodiment 38. The reaction mixture of embodiment 33, wherein the plasticizer is a pigment.

Embodiment 39. The reaction mixture of embodiment 33, wherein the plasticizer is polyethylene glycol dibenzoate.

Embodiment 40. The reaction mixture of embodiment 33, wherein the plasticizer is dioctyl phthalate.

Embodiment 41. A method for producing an impact resistant, biobased cast polyurethane resin, the method comprising preparing the reaction mixture of any one of embodiments 1-40, thereby producing the impact resistant, biobased cast polyurethane resin, wherein the impact resistant, biobased cast polyurethane resin has an impact resistance of greater than 20 kJ/m² as assessed by Charpy testing at −20° C.

Embodiment 42. The method of embodiment 41, wherein the impact resistant, biobased cast polyurethane resin has an impact resistance of greater than 30 kJ/m² as assessed by Charpy testing at −20° C.

Embodiment 43. The method of embodiment 41, wherein the impact resistant, biobased cast polyurethane resin has an impact resistance of greater than 70 kJ/m² as assessed by Charpy testing at −20° C.

Embodiment 44. The method of embodiment 41, wherein the impact resistant, biobased cast polyurethane resin has an impact resistance of greater than 140 kJ/m² as assessed by Charpy testing at −20° C.

Embodiment 45. The method of any one of embodiments 41-44, wherein the impact resistant, biobased cast polyurethane resin has a Shore D hardness of greater than 50 as assessed by durometer testing at −20° C.

Embodiment 46. The method of any one of embodiments 41-44, wherein the impact resistant, biobased cast polyurethane resin has a Shore D hardness of greater than 60 as assessed by durometer testing at −20° C.

Embodiment 47. The method of any one of embodiments 41-46, wherein the reaction mixture is cured at room temperature for at least 48 hours.

Embodiment 48. The method of any one of embodiments 41-46, wherein the reaction mixture is cured at room temperature for at least 24 hours.

Embodiment 49. The method of any one of embodiments 41-48, wherein the reaction mixture is cured at about 75° C. for at least 30 minutes.

Embodiment 50. The method of any one of embodiments 41-49, wherein the biobased polyol is at an amount of about 40% to about 65% on a weight-by-weight basis of the reaction mixture.

Embodiment 51. The method of any one of embodiments 41-50, wherein the biobased polyol is a TAG polyol.

Embodiment 52. The method of any one of embodiments 41-51, further comprising producing the biobased polyol from a microbial triglyceride oil.

Embodiment 53. The method of any one of embodiments 41-51, further comprising producing the biobased polyol from an algal triglyceride oil.

Embodiment 54. The method of any one of embodiments 41-53, further comprising obtaining the biobased polyol by epoxidation and ring opening of a biobased triglyceride oil.

Embodiment 55. The method of any one of embodiments 41-54, wherein the biobased polyol has an oleic acid content of greater than 60%.

Embodiment 56. The method of any one of embodiments 41-54, wherein the biobased polyol has an oleic acid content of greater than 80%.

Embodiment 57. The method of any one of embodiments 41-54, wherein the biobased polyol has an oleic acid content of greater than 90%.

Embodiment 58. The method of any one of embodiments 41-57, wherein the biobased polyol has a hydroxyl number of 150 to 165.

Embodiment 59. The method of any one of embodiments 41-58, wherein the isocyanate is at an amount of about 20% to about 40% on a weight-by-weight basis of the reaction mixture.

Embodiment 60. The method of any one of embodiments 41-59, wherein the isocyanate is a polymeric isocyanate.

Embodiment 61. The method of any one of embodiments 41-60, wherein the catalyst is at an amount of about 0.1% to about 0.5% on a weight-by-weight basis of the polyol.

Embodiment 62. The method of any one of embodiments 41-60, wherein the catalyst is at an amount of about 1% on a weight-by-weight basis of the reaction mixture.

Embodiment 63. The method of any one of embodiments 41-62, wherein the catalyst is an amine catalyst.

Embodiment 64. The method of any one of embodiments 41-62, wherein the catalyst is 1,4-diazabicyclo[2.2.2]octane (DABCO).

Embodiment 65. The method of any one of embodiments 41-62, wherein the catalyst is an organometallic catalyst.

Embodiment 66. The method of any one of embodiments 41-62, wherein the catalyst is an organotin catalyst, an organozinc catalyst, or an organozirconium catalyst.

Embodiment 67. The method of any one of embodiments 41-62, wherein the catalyst is an organotin catalyst.

Embodiment 68. The method of any one of embodiments 41-62, wherein the catalyst is dibutyltin dilaurate (DBTDL).

Embodiment 69. The method of any one of embodiments 41-68, wherein the zeolite is at an amount of about 1% to about 5% on a weight-by-weight basis of the reaction mixture.

Embodiment 70. The method of any one of embodiments 41-69, wherein the one or more macrodiols is at an amount of about 1% to about 10% on a weight-by-weight basis of the reaction mixture.

Embodiment 71. The method of any one of embodiments 41-69, wherein the one or more macrodiols is at an amount of about 5% to about 10% on a weight-by-weight basis of the reaction mixture.

Embodiment 72. The method of any one of embodiments 41-71, wherein the one or more macrodiols has a molecular weight of greater than 500.

Embodiment 73. The method of any one of embodiments 41-71, wherein the one or more macrodiols has a molecular weight of greater than 1000.

Embodiment 74. The method of any one of embodiments 41-71, wherein the one or more macrodiols has a molecular weight of greater than 2000.

Embodiment 75. The method of any one of embodiments 41-74, wherein the one or more macrodiols is a polybutadiene diol.

Embodiment 76. The method of any one of embodiments 41-74, wherein the one or more macrodiols is a polytetrahydrofuran.

Embodiment 77. The method of any one of embodiments 41-74, wherein the one or more macrodiols is a polybutadiene diol and a polytetrahydrofuran.

Embodiment 78. The method of any one of embodiments 41-77, wherein the one or more macrodiols is a biobased macrodiol.

Embodiment 79. The method of any one of embodiments 41-78, further comprising an additive at an amount of about 1% to about 30%.

Embodiment 80. The method of any one of embodiments 41-78, further comprising an additive at an amount of about 1% to about 20%.

Embodiment 81. The method of embodiment 79 or 80, wherein the additive is a plasticizer.

Embodiment 82. The method of embodiment 81, wherein the plasticizer is a biobased plasticizer.

Embodiment 83. The method of embodiment 81, wherein the plasticizer is a vegetable oil.

Embodiment 84. The method of embodiment 81, wherein the plasticizer is a microbial oil.

Embodiment 85. The method of embodiment 81, wherein the plasticizer is an algal oil.

Embodiment 86. The method of embodiment 81, wherein the plasticizer is a pigment.

Embodiment 87. The method of embodiment 81, wherein the plasticizer is polyethylene glycol dibenzoate.

Embodiment 88. The method of embodiment 81, wherein the plasticizer is dioctyl phthalate.

Embodiment 89. A method for preparing an impact resistant, biobased cast polyurethane resin, the method comprising reacting: a polyol at an amount of about 30% to about 70% on a weight-by-weight basis of the cast polyurethane resin; one or more macrodiols at an amount of about 1% to about 15% on a weight-by-weight basis of the cast polyurethane resin; and a zeolite at an amount of about 0.1% to about 5% on a weight-by-weight basis of the cast polyurethane resin with an isocyanate at an amount of about 15% to about 60% on a weight-by-weight basis of the cast polyurethane resin in the presence of a catalyst at an amount of about 0.1% to about 2% on a weight-by-weight basis of the cast polyurethane resin, thereby preparing the impact resistant, biobased cast polyurethane resin, wherein the impact resistant, biobased cast polyurethane resin has an impact resistance of greater than 20 kJ/m² as assessed by Charpy testing at −20° C.

Embodiment 90. An impact resistant, biobased cast polyurethane resin produced by the reaction mixture of any one of embodiments 1-40.

Embodiment 91. An impact resistant, biobased cast polyurethane resin produced by the method of any one of embodiments 41-89.

Embodiment 92. An impact resistant, biobased cast polyurethane resin comprising:
a) a biobased polyol at an amount of about 30% to about 70% on a weight-by-weight basis of the resin;
b) an isocyanate at an amount of about 15% to about 60% on a weight-by-weight basis of the resin;
c) a catalyst at an amount of about 0.1% to about 2% on a weight-by-weight basis of the resin;
d) a zeolite at an amount of about 0.1% to about 5% on a weight-by-weight basis of the resin; and
e) one or more macrodiols at an amount of about 1% to about 15% on a weight-by-weight basis of the resin.

Embodiment 93. The impact resistant, biobased cast polyurethane resin of embodiment 92, wherein the impact resistant, biobased cast polyurethane resin has an impact resistance of greater than 20 kJ/m² as assessed by Charpy testing at −20° C.

Embodiment 94. The impact resistant, biobased cast polyurethane resin of embodiment 92, wherein the impact resistant, biobased cast polyurethane resin has an impact resistance of greater than 30 kJ/m² as assessed by Charpy testing at −20° C.

Embodiment 95. The impact resistant, biobased cast polyurethane resin of any one of embodiments 92-94, wherein the impact resistant, biobased cast polyurethane resin has a Shore D hardness of greater than 50 as assessed by durometer testing at −20° C.

Embodiment 96. The impact resistant, biobased cast polyurethane resin of any one of embodiments 92-94, wherein the impact resistant, biobased cast polyurethane resin has a Shore D hardness of greater than 60 as assessed by durometer testing at −20° C.

Embodiment 97. The impact resistant, biobased cast polyurethane resin of any one of embodiments 92-96, wherein the biobased polyol is at an amount of about 40% to about 65% on a weight-by-weight basis of the resin.

Embodiment 98. The impact resistant, biobased cast polyurethane resin of any one of embodiments 92-97, wherein the biobased polyol is a TAG polyol.

Embodiment 99. The impact resistant, biobased cast polyurethane resin of any one of embodiments 92-98, wherein the biobased polyol is derived from a microbial triglyceride oil.

Embodiment 100. The impact resistant, biobased cast polyurethane resin of any one of embodiments 92-98, wherein the biobased polyol is derived from an algal triglyceride oil.

Embodiment 101. The impact resistant, biobased cast polyurethane resin of any one of embodiments 92-100, wherein the biobased polyol is derived from epoxidation and ring opening of a biobased triglyceride oil.

Embodiment 102. The impact resistant, biobased cast polyurethane resin of any one of embodiments 92-101, wherein the biobased polyol has an oleic acid content of greater than 60%.

Embodiment 103. The impact resistant, biobased cast polyurethane resin of any one of embodiments 92-101, wherein the biobased polyol has an oleic acid content of greater than 80%.

Embodiment 104. The impact resistant, biobased cast polyurethane resin of any one of embodiments 92-101, wherein the biobased polyol has an oleic acid content of greater than 90%.

Embodiment 105. The impact resistant, biobased cast polyurethane resin of any one of embodiments 92-104, wherein the biobased polyol has a hydroxyl number of 150 to 165.

Embodiment 106. The impact resistant, biobased cast polyurethane resin of any one of embodiments 92-105, wherein the isocyanate is at an amount of about 20% to about 40% on a weight-by-weight basis of the resin.

Embodiment 107. The impact resistant, biobased cast polyurethane resin of any one of embodiments 92-106, wherein the isocyanate is a polymeric isocyanate.

Embodiment 108. The impact resistant, biobased cast polyurethane resin of any one of embodiments 92-107, wherein the catalyst is at an amount of about 0.1% to about 0.5% on a weight-by-weight basis of the polyol.

Embodiment 109. The impact resistant, biobased cast polyurethane resin of any one of embodiments 92-107, wherein the catalyst is at an amount of about 1% on a weight-by-weight basis of the resin.

Embodiment 110. The impact resistant, biobased cast polyurethane resin of any one of embodiments 92-109, wherein the catalyst is an amine catalyst.

Embodiment 111. The impact resistant, biobased cast polyurethane resin of any one of embodiments 92-109, wherein the catalyst is 1,4-diazabicyclo[2.2.2]octane (DABCO).

Embodiment 112. The impact resistant, biobased cast polyurethane resin of any one of embodiments 92-109, wherein the catalyst is an organometallic catalyst.

Embodiment 113. The impact resistant, biobased cast polyurethane resin of any one of embodiments 92-109, wherein the catalyst is an organotin catalyst, an organozinc catalyst, or an organozirconium catalyst.

Embodiment 114. The impact resistant, biobased cast polyurethane resin of any one of embodiments 92-109, wherein the catalyst is an organotin catalyst.

Embodiment 115. The impact resistant, biobased cast polyurethane resin of any one of embodiments 92-109, wherein the catalyst is dibutyltin dilaurate (DBTDL).

Embodiment 116. The impact resistant, biobased cast polyurethane resin of any one of embodiments 92-115, wherein the zeolite is at an amount of about 1% to about 5% on a weight-by-weight basis of the resin.

Embodiment 117. The impact resistant, biobased cast polyurethane resin of any one of embodiments 92-116, wherein the one or more macrodiols is at an amount of about 1% to about 10% on a weight-by-weight basis of the resin.

Embodiment 118. The impact resistant, biobased cast polyurethane resin of any one of embodiments 92-116, wherein the one or more macrodiols is at an amount of about 5% to about 10% on a weight-by-weight basis of the resin.

Embodiment 119. The impact resistant, biobased cast polyurethane resin of any one of embodiments 92-118, wherein the one or more macrodiols has a molecular weight of greater than 500.

Embodiment 120. The impact resistant, biobased cast polyurethane resin of any one of embodiments 92-118, wherein the one or more macrodiols has a molecular weight of greater than 1000.

Embodiment 121. The impact resistant, biobased cast polyurethane resin of any one of embodiments 92-118, wherein the one or more macrodiols has a molecular weight of greater than 2000.

Embodiment 122. The impact resistant, biobased cast polyurethane resin of any one of embodiments 92-121, wherein the one or more macrodiols is a polybutadiene diol.

Embodiment 123. The impact resistant, biobased cast polyurethane resin of any one of embodiments 92-121, wherein the one or more macrodiols is a polytetrahydrofuran.

Embodiment 124. The impact resistant, biobased cast polyurethane resin of any one of embodiments 92-121, wherein the one or more macrodiols is a polybutadiene diol and a polytetrahydrofuran.

Embodiment 125. The impact resistant, biobased cast polyurethane resin of any one of embodiments 92-124, wherein the one or more macrodiols is a biobased macrodiol.

Embodiment 126. The impact resistant, biobased cast polyurethane resin of any one of embodiments 92-125, further comprising an additive at an amount of about 1% to about 30%.

Embodiment 127. The impact resistant, biobased cast polyurethane resin of any one of embodiments 92-125, further comprising an additive at an amount of about 1% to about 20%.

Embodiment 128. The impact resistant, biobased cast polyurethane resin of embodiment 126 or 127, wherein the additive is a plasticizer.

Embodiment 129. The impact resistant, biobased cast polyurethane resin of embodiment 128, wherein the plasticizer is a biobased plasticizer.

Embodiment 130. The impact resistant, biobased cast polyurethane resin of embodiment 128, wherein the plasticizer is a vegetable oil.

Embodiment 131. The impact resistant, biobased cast polyurethane resin of embodiment 128, wherein the plasticizer is a microbial oil.

Embodiment 132. The impact resistant, biobased cast polyurethane resin of embodiment 128, wherein the plasticizer is an algal oil.

Embodiment 133. The impact resistant, biobased cast polyurethane resin of embodiment 128, wherein the plasticizer is a pigment.

Embodiment 134. The impact resistant, biobased cast polyurethane resin of embodiment 128, wherein the plasticizer is polyethylene glycol dibenzoate.

Embodiment 135. The impact resistant, biobased cast polyurethane resin of embodiment 126, wherein the plasticizer is dioctyl phthalate.

Embodiment 136. A polyurethane comprising polyol derived from an algal triglyceride oil; a diol having a molecular weight of greater than 1000; and an isocyanate, wherein the algal triglyceride oil comprises >90% oleic acid, wherein the polyol has an OH # between 150 and 165.

Embodiment 137. A polyurethane comprising polyol derived from an algal triglyceride oil; a diol having a molecular weight of greater than 1000; a plasticizer; and an isocyanate, wherein the algal triglyceride oil comprises >90% oleic acid, wherein the polyol has an OH # between 150 and 165.

Embodiment 138. The polyurethane of embodiment 136 or 137, wherein the plasticizer is polyethylene glycol dibenzoate.

Embodiment 139. The polyurethane of embodiment 136 or 137, wherein the plasticizer is dioctyl phthalate.

Embodiment 140. A kit comprising:
a) an isocyanate component, wherein the isocyanate component comprises:
   i) 95% to 99% of an isocyanate on a weight-by-weight basis; and
   ii) 1% to 5% of an algal oil polyol on a weight-by-weight basis; and
b) a polyol component, wherein the polyol component comprises:
   i) 80% to 85% of the algal oil polyol on a weight-by-weight basis;
   ii) 1% to 10% of 1,4-butanediol on a weight-by-weight basis;
   iii) 1% to 5% of a zeolite on a weight-by-weight basis;
   iv) 1% to 5% of one or more pigments on a weight-by-weight basis; and
   v) 0.001% to 1% of a catalyst on a weight-by-weight basis.

Embodiment 141. A kit comprising:
a) an isocyanate component, wherein the isocyanate component comprises:
   i) 85% to 90% of an isocyanate on a weight-by-weight basis; and
   ii) 10% to 15% of an algal oil polyol on a weight-by-weight basis; and
b) a polyol component, wherein the polyol component comprises:
   i) 80% to 85% of the algal oil polyol on a weight-by-weight basis;
   ii) 1% to 10% of a polybutadiene diol on a weight-by-weight basis;
   iii) 1% to 5% of a zeolite on a weight-by-weight basis;
   iv) 1% to 5% of one or more pigments on a weight-by-weight basis; and
   v) 0.01% to 1% of a catalyst on a weight-by-weight basis.

Embodiment 142. A kit comprising:
a) an isocyanate component, wherein the isocyanate component comprises:
   i) 80% to 85% of an isocyanate on a weight-by-weight basis;
   ii) 10% to 15% of an algal oil polyol on a weight-by-weight basis; and
   iii) 1% to 5% of a refined, bleached, and deodorized algal oil; and
b) a polyol component, wherein the polyol component comprises:
   i) 80% to 85% of the algal oil polyol on a weight-by-weight basis;
   ii) 5% to 10% of a refined, bleached, and deodorized algal oil;
   iii) 1% to 5% of 1,4-butanediol on a weight-by-weight basis;
   iv) 1% to 5% of a polybutadiene diol on a weight-by-weight basis;
   v) 1% to 5% of a zeolite on a weight-by-weight basis;
   vi) 1% to 5% of one or more pigments on a weight-by-weight basis; and
   vii) 0.1% to 1% of a catalyst on a weight-by-weight basis.

Embodiment 143. A kit comprising:
a) an isocyanate component, wherein the isocyanate component comprises:
   i) 70% to 80% of an isocyanate on a weight-by-weight basis;
   ii) 10% to 15% of an algal oil polyol on a weight-by-weight basis; and
   iii) 10% to 15% of a refined, bleached, and deodorized algal oil; and
b) a polyol component, wherein the polyol component comprises:
   i) 70% to 80% of the algal oil polyol on a weight-by-weight basis;
   ii) 10% to 15% of a refined, bleached, and deodorized algal oil;
   iii) 5% to 10% of a polybutadiene diol on a weight-by-weight basis;
   iv) 1% to 5% of a zeolite on a weight-by-weight basis;
   v) 1% to 5% of one or more pigments on a weight-by-weight basis; and
   vi) 0.1% to 1% of a catalyst on a weight-by-weight basis.

Embodiment 144. A kit comprising:
a) an isocyanate component, wherein the isocyanate component comprises:
   i) 70% to 80% of an isocyanate on a weight-by-weight basis;
   ii) 10% to 20% of an algal oil polyol on a weight-by-weight basis; and
   iii) 5% to 10% of a refined, bleached, and deodorized algal oil; and
b) a polyol component, wherein the polyol component comprises:
   i) 80% to 85% of the algal oil polyol on a weight-by-weight basis;
   ii) 1% to 5% of 1,4-butanediol on a weight-by-weight basis;
   iii) 5% to 10% of a polybutadiene diol on a weight-by-weight basis;
   iv) 1% to 5% of a zeolite on a weight-by-weight basis;
   v) 1% to 5% of one or more pigments on a weight-by-weight basis; and
   vi) 0.1% to 1% of a catalyst on a weight-by-weight basis.

Embodiment 145. The kit of any one of embodiments 140-144, further comprising written instructions on use of the kit for making a cast polyurethane by mixing together the isocyanate component and the polyol component.

Embodiment 146. An impact resistant, biobased cast polyurethane resin comprising 2% to 20% of a triglyceride oil on a weight-by-weight basis, wherein the impact resistant, biobased cast polyurethane resin has an impact resistance of greater than 130 kJ/m² as assessed by Charpy testing at −20° C. or lower, and wherein the impact resistant, biobased cast polyurethane resin has a Shore D hardness of greater than 50 as assessed by durometer testing at −20° C. or lower.

Embodiment 147. The impact resistant, biobased cast polyurethane resin of embodiment 146, wherein the triglyceride oil comprises at least 60% of oleic acid.

Embodiment 148. The impact resistant, biobased cast polyurethane resin of embodiment 146 or 147, wherein the triglyceride oil comprises at least 80% of oleic acid.

Embodiment 149. The impact resistant, biobased cast polyurethane resin of any one of embodiments 146-148, wherein the triglyceride oil comprises at least 80% triolein.

Embodiment 150. The impact resistant, biobased cast polyurethane resin of any one of embodiments 146-149, wherein the triglyceride oil is an algal oil.

Embodiment 151. The impact resistant, biobased cast polyurethane resin of any one of embodiments 146-151, wherein the triglyceride oil is a refined, bleached, and deodorized algal oil.

Embodiment 152. The impact resistant, biobased cast polyurethane resin of any one of embodiments 90-135 and 146-151 for use in a winter sporting goods equipment selected from the group consisting of skis, split boards, and snowboards.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A reaction mixture comprising:
a) a biobased polyol at an amount of about 30% to about 70% on a weight-by-weight basis of the reaction mixture;
b) an isocyanate at an amount of about 15% to about 60% on a weight-by-weight basis of the reaction mixture;
c) a catalyst at an amount of about 0.1% to about 2% on a weight-by-weight basis of the reaction mixture;
d) a zeolite at an amount of about 0.1% to about 5% on a weight-by-weight basis of the reaction mixture; and
e) one or more macrodiols at an amount of about 1% to about 15% on a weight-by-weight basis of the reaction mixture.

2. (canceled)

3. The reaction mixture of claim 1, wherein the biobased polyol is a triacylglyceride (TAG) polyol.

4. The reaction mixture of claim 1, wherein the biobased polyol is derived from a microbial triglyceride oil.

5. The reaction mixture of claim 1, wherein the biobased polyol is derived from an algal triglyceride oil.

6. The reaction mixture of claim 1, wherein the biobased polyol is derived from epoxidation and ring opening of a biobased triglyceride oil.

7-9. (canceled)

10. The reaction mixture of claim 1, wherein the biobased polyol has a hydroxyl number of 150 to 165.

11. (canceled)

12. The reaction mixture of claim 1, wherein the isocyanate is a polymeric isocyanate.

13. The reaction mixture of claim 1, wherein the catalyst is at an amount of about 0.1% to about 0.5% on a weight-by-weight basis of the biobased polyol.

14. The reaction mixture of claim 1, wherein the catalyst is at an amount of about 1% on a weight-by-weight basis of the reaction mixture.

15. The reaction mixture of claim 1, wherein the catalyst is an amine catalyst.

16. The reaction mixture of claim 1, wherein the catalyst is 1,4-diazabicyclo[2.2.2]octane (DABCO) or dibutyltin dilaurate (DBTDL).

17-20. (canceled)

21. The reaction mixture of claim 1, wherein the zeolite is at an amount of about 1% to about 5% on a weight-by-weight basis of the reaction mixture.

22. The reaction mixture of claim 1, wherein the one or more macrodiols is at an amount of about 1% to about 10% on a weight-by-weight basis of the reaction mixture.

23. (canceled)

24. The reaction mixture of claim 1, wherein the one or more macrodiols has a molecular weight of greater than 500.

25. The reaction mixture of claim 1, wherein the one or more macrodiols has a molecular weight of greater than 1000.

26. (canceled)

27. The reaction mixture of claim 1, wherein the one or more macrodiols is a polybutadiene diol, a polytetrahydrofuran, or a polycarbonate diol.

28. (canceled)

29. The reaction mixture of claim 1, wherein the one or more macrodiols is a polybutadiene diol and a polytetrahydrofuran.

30. The reaction mixture of claim 1, wherein the one or more macrodiols is a biobased macrodiol.

31. The reaction mixture of claim 1, further comprising an additive at an amount of about 1% to about 30%.

32. (canceled)

33. The reaction mixture of claim 31, wherein the additive is a plasticizer.

34. The reaction mixture of claim 33, wherein the plasticizer is a biobased plasticizer.

35. (canceled)

36. The reaction mixture of claim 33, wherein the plasticizer is a microbial oil.

37. The reaction mixture of claim 33, wherein the plasticizer is an algal oil.

38. The reaction mixture of claim 33, wherein the plasticizer is selected from the group consisting of a vegetable oil, a pigment, polyethylene glycol dibenzoate, and dioctyl phthalate.

39-91. (canceled)

92. An impact resistant, biobased cast polyurethane resin comprising:
a) a biobased polyol at an amount of about 30% to about 70% on a weight-by-weight basis of the resin;
b) an isocyanate at an amount of about 15% to about 60% on a weight-by-weight basis of the resin;
c) a catalyst at an amount of about 0.1% to about 2% on a weight-by-weight basis of the resin;
d) a zeolite at an amount of about 0.1% to about 5% on a weight-by-weight basis of the resin; and
e) one or more macrodiols at an amount of about 1% to about 15% on a weight-by-weight basis of the resin,
wherein the impact resistant, biobased cast polyurethane resin has an impact resistance of greater than 20 kJ/m² as assessed by Charpy testing at −20° C.

93-152. (canceled)

153. The reaction mixture of claim 1, wherein the reaction mixture has a biobased content of at least about 65%.
